(19) United States
(12) Patent Application Publication
(10) Pub. No.: US 2019/0358546 A1
(43) Pub. Date: Nov. 28, 2019

(54) VIDEO GAME PROCESSING PROGRAM AND GAME SYSTEM

(71) Applicant: SQUARE ENIX CO., LTD., Tokyo (JP)

(72) Inventors: Takami DAIZABURO, Tokyo (JP); Motohashi TAISA, Tokyo (JP)

(73) Assignee: SQUARE ENIX CO., LTD., Tokyo (JP)

(21) Appl. No.: 16/418,024

(22) Filed: May 21, 2019

(30) Foreign Application Priority Data
May 25, 2018 (JP) 2018-100097

(51) Int. Cl. A63F 13/79; A63F 13/35; A63F 13/85

(52) U.S. Cl. CPC A63F 13/79; A63F 13/35; A63F 2300/64; A63F 2300/5533; A63F 13/85

(57) ABSTRACT

There is provided a video game processing program that causes a computer to realize a function of controlling a progression of a video game in which each group is formed by a plurality of objects containing player objects which are respectively manipulated by players of a plurality of terminal devices connected together via a communication network, the program causing the computer to realize a first configuration function that configures a group to which each of the plurality of objects belongs; a motion control function that controls motions of the plurality of objects; a second configuration function that, based on a predetermined motion executed by a player object, configures at least one object of the plurality of objects as a target of a group to which the player object belongs; and a generation function that generates a subsidiary object linking the target to each player object belonging to the group.

### BACKGROUND OF THE INVENTION

### 1. Field of the Invention

At least one embodiment of the present disclosure relates to a video game processing program that controls a progression of a video game in which each group is formed in a game space by a plurality of objects containing player objects that are respectively manipulated by players of a plurality of terminal devices.

### 2. Description of Related Art

A server device connected to a communication network such as Internet provides an online game or the like for a game terminal device (terminal device). The online game provides also a communication function such as chat for communicating with other players (for example, refer to JP-A-2017-042362). A player delivers the player's own thoughts or emotions to other players via the function, who participate in the game.

### SUMMARY OF THE INVENTION

The communication function is effective in delivering the player's thoughts or emotions to other players, and on the one hand, a game with the communication function has the task of improving convenience which allows the player to more easily communicate with other players during a play of the game.

An object of at least one embodiment of the invention is to solve a lack of the related technologies.

From a non-limiting point of view, according to an embodiment of the invention, there is provided a video game processing program that causes a computer to realize a function of controlling a progression of a video game in which each group is formed in a game space by a plurality of objects containing player objects which are respectively manipulated by players of a plurality of terminal devices connected together via a communication network, the program causing the computer to realize a display control function that displays an image of the game space on a display unit of each of the plurality of terminal devices; a first configuration function that configures a group to which each of the plurality of objects belongs; a motion control function that controls motions of the plurality of objects; a second configuration function that configures at least one object of the plurality of objects as a target of a group to which a player object belongs, based on a predetermined motion executed by the player object; and a generation function that generates a subsidiary object linking the target of the group to each player object belonging to the group.

From a non-limiting point of view, according to an embodiment of the invention, there is provided a video game processing program that causes a server device to control a progression of a video game in which each group is formed in a game space by a plurality of objects containing player objects which are respectively manipulated by players of a plurality of terminal devices connected with the server device via a communication network, the program causing the server device to realize a display control function that displays an image of the game space on a display unit of each of the plurality of terminal devices; a first configuration function that configures a group to which each of the plurality of objects belongs; a motion control function that controls motions of the plurality of objects; a second configuration function that configures at least one object of the plurality of objects as a target of a group to which a player object belongs, based on a predetermined motion executed by the player object; and a generation function that generates a subsidiary object linking the target of the group to each player object belonging to the group.

From a non-limiting point of view, according to still an embodiment of the invention, there is provided a game system that includes a plurality of terminal devices executing a video game in which each group is formed in a game space by a plurality of objects containing player objects which are respectively manipulated by a plurality of players, and a server device connected with the plurality of terminal devices via a communication network, the system including a display controller that displays an image of the game space on a display unit of each of the plurality of terminal devices; a first configurator that configures a group to which each of the plurality of objects belongs; a motion controller that controls motions of the plurality of objects; a second configurator that configures at least one object of the plurality of objects as a target of a group to which a player object belongs, based on a predetermined motion executed by the player object; and a generator that generates a subsidiary object linking the target of the group to each player object belonging to the group.

One, or two or more problems are solved by the respective embodiments of the present application.

### BRIEF DESCRIPTION OF THE DRAWINGS

FIG. 1 is a block diagram illustrating an example of a configuration of a game system corresponding to at least one of the embodiments of the invention.

FIG. 2 is a block diagram illustrating an example of a configuration of a server device corresponding to at least one of the embodiments of the invention.

FIG. 3 is a flowchart illustrating an example of a game progression process corresponding to at least one of the embodiments of the invention.

FIG. 4 is a block diagram illustrating an example of a configuration of a game system corresponding to at least one of the embodiments of the invention.

FIG. 5 is a flowchart illustrating an example of motions of a host terminal device and guest terminal devices when the host terminal device executes the game progression process corresponding to at least one of the embodiments of the invention.

FIG. 6 is a block diagram illustrating an example of a configuration of a terminal device corresponding to at least one of the embodiments of the invention.

FIG. 7 is a diagram illustrating an example of a determination table corresponding to at least one of the embodiments of the invention.

FIG. 8 is a flowchart illustrating an example of a game progression process corresponding to at least one of the embodiments of the invention.

FIG. 9 is a block diagram illustrating an example of a configuration of a server device corresponding to at least one of the embodiments of the invention.

FIG. 10 is a flowchart illustrating an example of a game progression process corresponding to at least one of the embodiments of the invention.

FIG. 11 is a block diagram illustrating an example of a configuration of a server device corresponding to at least one of the embodiments of the invention.

FIG. 12 is a flowchart illustrating an example of a game progression process corresponding to at least one of the embodiments of the invention.

FIG. 13 is a block diagram illustrating an example of a configuration of a server device corresponding to at least one of the embodiments of the invention.

FIG. 14 is a flowchart illustrating an example of a game progression process corresponding to at least one of the embodiments of the invention.

FIG. 15 is a schematic view illustrating an example of a game space corresponding to at least one the embodiments of the invention.

FIG. 16 is a view illustrating an example of a game image corresponding to at least one of the embodiments of the invention.

FIGS. 17A and 17B are views illustrating examples of a game image corresponding to at least one of the embodiments of the invention.

FIG. 18 is a schematic view illustrating an example of a game space corresponding to at least one of the embodiments of the invention.

FIGS. 19A to 19C are views illustrating an example of a stamp (object) corresponding to at least one of the embodiments of the invention.

FIGS. 20A and 20B are diagrams respectively illustrating examples of a determination table and a target list corresponding to at least one of the embodiments of the invention.

FIG. 21 is a diagram illustrating an example of a mission list corresponding to at least one of the embodiments of the invention.

FIG. 22 is a block diagram illustrating an example of a configuration of a server device corresponding to at least one of the embodiments of the invention.

FIGS. 23A and 23B are diagrams respectively illustrating examples of a participating player list and an object list (player character) corresponding to at least one of the embodiments of the invention.

FIG. 24 is a diagram illustrating an example of an in-progress mission list corresponding to at least one of the embodiments of the invention.

FIG. 25 is a flowchart illustrating an example of a game progression process corresponding to at least one of the embodiments of the invention.

### DESCRIPTION OF EMBODIMENTS

Examples of embodiments of the invention will be described with reference to the drawings hereinbelow. In the examples of the embodiments which will be described hereinbelow, various components can be appropriately combined together unless there exist inconsistencies or the like therebetween. A description of contents in an example of an embodiment may be omitted in other embodiments. A description of a motion and a process which are not related to features of each embodiment maybe omitted. The sequences of various processes illustrating various flows which will be described hereinbelow may be changed unless there exist inconsistencies or the like in contents of the processes.

### First Embodiment

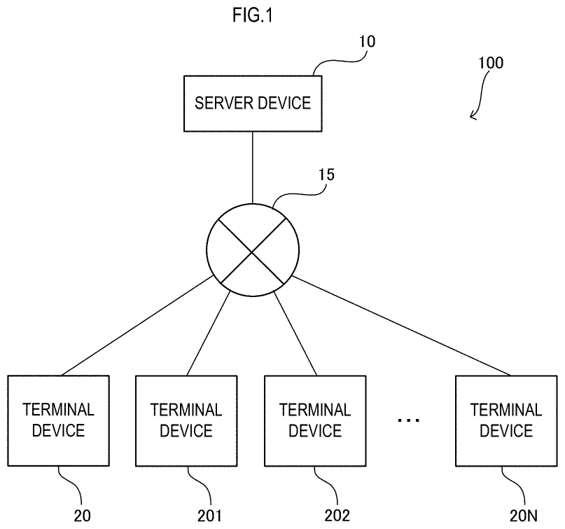

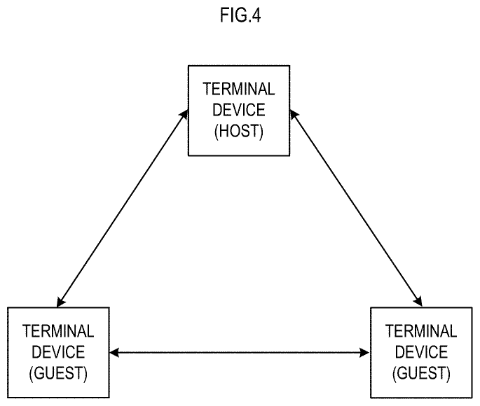

FIG. 1 is a block diagram illustrating an example of a configuration of a game system 100 according to one embodiment of the invention. As illustrated in FIG. 1, the game system 100 includes a server device 10 and terminal devices 20 and 201 to 20N (game terminal devices 20 and 201 to 20N) (N is an arbitrary integer) that are respectively used by a plurality of users (players) playing a video game (game). The server device 10 and the plurality of terminal devices 20 and 201 to 20N are connected to a communication network such as Internet. The configuration of the game system 100 is not limited to the configuration described above, and may include a plurality of server devices or may not include a server device (refer to FIG. 4).

The game system 100 has various functions for executing a game where groups are formed in a game space by a plurality of objects containing player objects. An example of the game where the groups are formed is a combat game between groups of teams.

The plurality of objects may contain at least the player objects manipulated (moved) by the players. The plurality of objects may contain an object of a facility which has to be attacked or defended by a player object, and an object of a non-player character (non-player object), the motion of which is controlled by the server device (CPU) 10.

In the game of the embodiment, a target of a group is configured. The target of the group is an object which is a target for a motion such as attack or defense which is executed by the group. The target of the group is configured by a predetermined motion executed by player objects. Specifically, based on the predetermined motion executed by the player objects, at least one object of a plurality of objects is configured as a target of a group to which the player objects belong.

When a target of a group is configured, a subsidiary object is generated to link the target to each of player objects belonging to the group. The players see the subsidiary objects, and thus recognize which object is the target of the group to which the players themselves belong and where the target is positioned in the game space.

The predetermined motion implies, for example, a motion where the player object shoots a moving body object such as a bullet at an other object and hit the other object.

The server device 10 is managed by a game system administrator, and has various functions for providing game progression information for the terminal devices 20 and 201 to 20N. In the embodiment, the server device 10 provides information on targets of the groups, the subsidiary objects, and the like for the terminal devices 20 and 201 to 20N. In the embodiment, the server device 10 is made up of an information processing device such as WWW server to provide video game progression information, and includes a database (storage unit) storing various information.

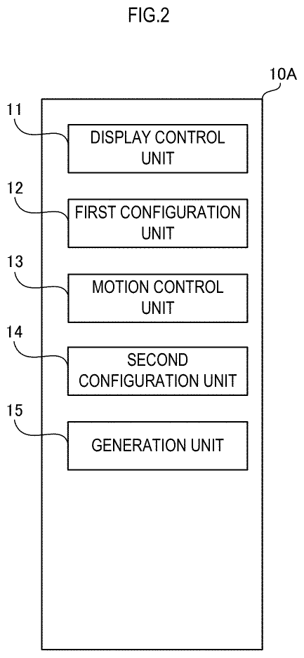

FIG. 2 is a functional block diagram illustrating a configuration of a server device 10A, which is an example of the configuration of the server device 10. The server device 10A includes a storage unit (not illustrated) such as HDD, and a control unit made up of CPU, and detailed descriptions of the storage unit and the control unit will be omitted. The control unit executes software (video game processing program) for controlling a progression of a video game, which is stored in the storage unit, and the server device 10A includes a display control unit 11, a first configuration unit 12, a motion control unit 13, a second configuration unit 14, and a generation unit 15. The video game processing program contains also game data.

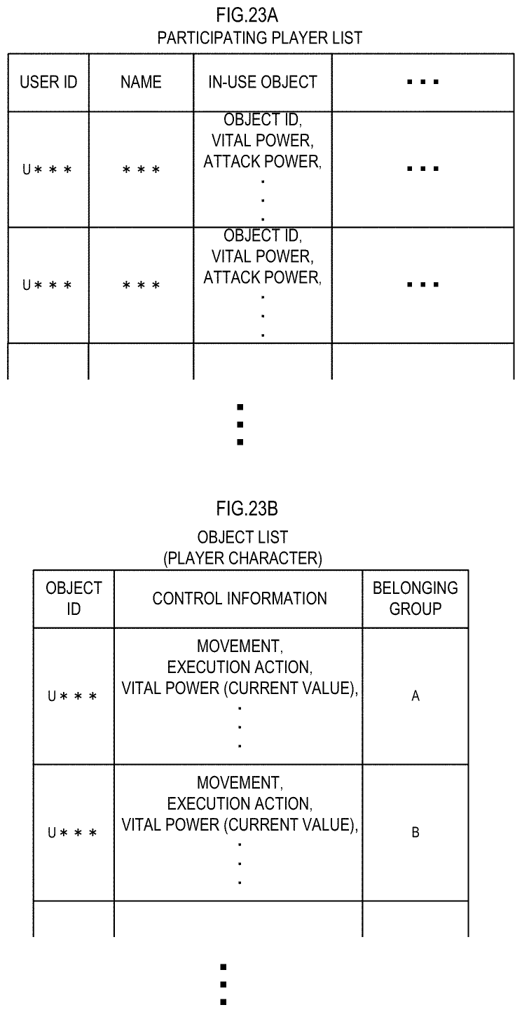

The display control unit (display control function) 11 displays an image (game image) of a game space on a display unit of each of a plurality of the terminal devices 20 and 201 to 20N. The display control unit 11 transmits control information (object control information) of objects to the terminal devices 20 and 201 to 20N as common image information. The object control information is, for example, information on motions of objects, and contains movement (position) information, action execution information, and the like. The object control information may be stored in the storage unit of the server device 10A while being mapped onto corresponding object identification information (for example, refer to the object list of FIG. 23B). The terminal devices 20 and 201 to 20N generate an image based on the image information, and display the image on the display units. Because the image is displayed based on the image information in a typical manner, a detailed description thereof will be omitted.

The display control unit 11 may generate and transmit, for example, information on one frame of image (game image) as image information, which is displayed on the display units of the terminal devices 20 and 201 to 20N. In this case, the terminal devices 20 and 201 to 20N can display an image on the display units as it is, which is based on the received image information.

The first configuration unit (first configuration function) 12 configures a group to which each of a plurality of the objects belongs. That is, the first configuration unit groups the plurality of objects. Belonging group information may be stored along with the object control information while being mapped onto the object identification information. The number of the groups maybe two or more. The grouping can be done in an arbitrary manner. The plurality of objects which are configuration targets of groups may be randomly divided into a predetermined number of groups.

The player objects may not be divided into all of the groups. A group of the player objects and a group of the non-player objects only may be formed. Groups may not be configured for all of the objects in the game space. A group is configured, for example, for objects corresponding to preconfigured identification information. A group may be configured, for example, for only the player objects.

The motion control unit (motion control function) 13 controls motions (actions) of the plurality of objects. The motion control unit 13 controls, for example, the motions based on update information of the player objects, which is acquired from the terminal devices 20 and 201 to 20N. The update information contains, for example, manipulation information of the player objects. In this case, the motion control unit 13 executes a motion such as movement of each player object based on the manipulation information. The motion control unit 13 controls also motions of objects (for example, non-player characters) other than the player objects. The motion control unit 13 updates the object control information.

The motion control unit 13 may acquire the control information (for example, information on movements (positions) of the player objects in the game space and the action execution information) from the terminal devices 20 and 201 to 20N as the update information instead of the manipulation information. That is, a motion of a player object manipulated by a player is executed in a terminal device used by the player, and updated player object control information is transmitted to the server device 10A from the terminal as update information. The motion control unit 13 may control each object by collecting the acquired update information of the player objects, and updating the acquired update information as object control information.

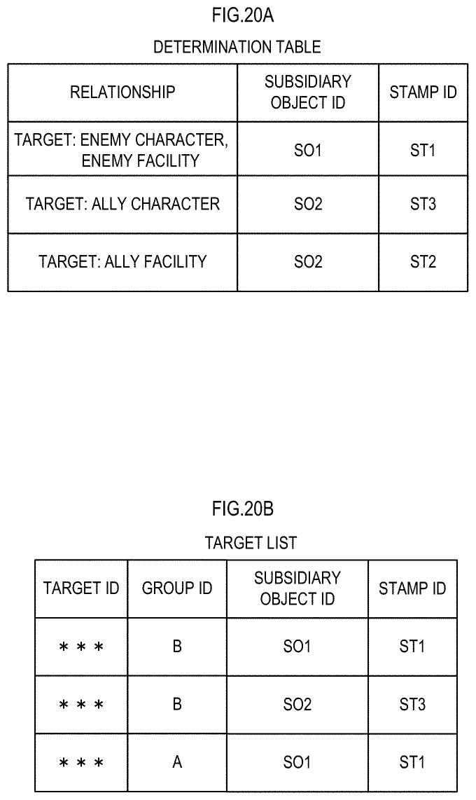

The second configuration unit (second configuration function) 14 configures at least one object of the plurality of objects as the target of the group, to which the player objects belong, based on the predetermined motion executed by the player objects. The second configuration unit 14 may store target configuration information, in which identification information of the object which is the target is mapped onto group identification information, in the storage unit of the server device 10A (for example, refer to the target list illustrated in FIG. 20B).

The generation unit (generation function) 15 generates a subsidiary object linking a target of a group to each of player objects belonging to the group. The generation implies that the subsidiary objects are added to the game space as objects. The generation unit 15 generates the subsidiary objects by configuring subsidiary object identification information as objects. Specifically, the generation unit 15 configures the subsidiary object identification information while the subsidiary object identification information is mapped onto the identification information of the object which is the target, and is contained in the target configuration information.

The display control unit 11 transmits, for example, information on the generated subsidiary objects to the terminal devices 20 and 201 to 20N while the information is also contained in the image information. For example, the target configuration information containing the subsidiary object identification information is transmitted while being contained in the image information. The terminal devices 20 and 201 to 20N display an image of the game space based on the object control information, the target subsidiary object, and the like such that the image contains the subsidiary objects linking the target to each of the player objects belonging to the group. The target configuration information specifies which object is a targeted object. The position of the target and the like is specified from control information of the specified object.

Each of the terminal devices 20 and 201 to 20N is managed by a user (player) playing a game. Each of the terminal devices 20 and 201 to 20N is a terminal device such as a personal computer, a mobile phone, a personal digital assistant (PDA), or a portable game terminal device in which a video game can be executed.

Each of the terminal devices 20 and 201 to 20N includes a manipulation device (manipulation unit), a storage unit such as HDD, a control unit made up of a CPU and the like which executes the game and generate game images, a display device (display unit) displaying the game images, a transreceiving unit communicating with other devices, and the like, and detailed descriptions thereof will be omitted. The storage units of the terminal devices 20 and 201 to 20N store software (video game execution program) for executing the game via communication with the server device 10A. The terminal devices 20 and 201 to 20N receive, for example, object movement information, action execution information, and the like, and generates an image of the game space, which is displayed on the display units.

Subsequently, a motion of the game system 100 (system 100) of the embodiment will be described.

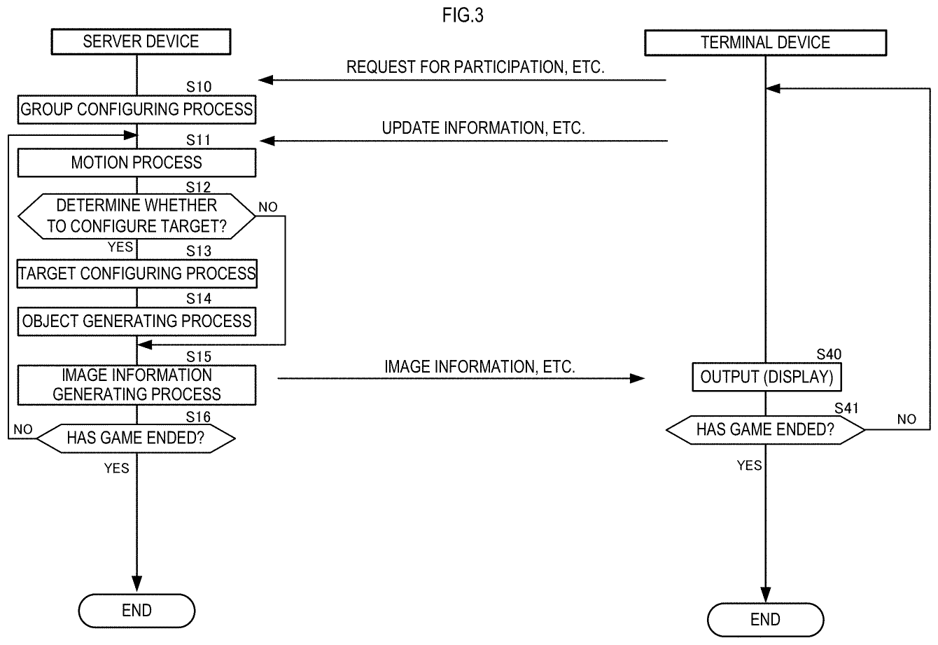

FIG. 3 is a flowchart illustrating an example of a progression process of a game which is executed by the system 100. In the progression process of the embodiment, a game progression process containing a group configuring process, a group target configuring process, and a subsidiary object generating process is executed. In FIG. 3, the group configuring process, the group target configuring process, the subsidiary object generating process will be mainly described, and part of other processes will be omitted. In a description of an example hereinbelow, the server device 10A and the terminal device 20 execute the progression process.

The progression process of the embodiment is executed in response to the occasion that a player generates a manipulation input for requesting game participation.

In the progression process, the terminal device 20 transmits game participation request information to the server device 10A. The participation request information contains, for example, basic information of a player object manipulated by the player, an IP address, user identification information, and the like. The player object basic information contains player object identification information and basic values of various parameters, for example, a maximum value of a vital power.

The server device 10A executes the group configuring process (Step S10). The server device 10A configures a group for each of a plurality of objects containing a player object which is a configuration target of the group. As described above, for example, group identification information may be mapped onto object control information.

Thereafter, a game space is generated, and the game starts. The terminal device 20 regularly transmits player object update information (manipulation information and the like) and the user identification information to the server device 10A.

The server device 10A executes a motion process of the objects in the game space (Step S11). As described above, the server device 10A controls motions of at least a plurality of the objects, for which a group is configured, based on the player object update information and the like. Therefore, object control information, for example, information on movements (positions) of the plurality of objects in the game space and action execution information, is updated.

Subsequently, the server device 10A determines whether to configure targets of the groups (Step S12). Specifically, the server device 10A makes the determination based on a predetermined motion executed by each of the player objects belonging to the groups. Therefore, for example, when the predetermined motion is not executed by any of the player objects, the targets are not configured. The information updated in Step S11 may be referred to for the motion of each player object.

When it is determined that the configuring of the target is not required (Step S12: NO), the server device 10A proceeds to the process of Step S15. On the other hand, when it is determined that the configuring of the target is required (Step S12: YES), the server device 10A executes the target configuring process (Step S13). Specifically, based on the predetermined motion executed by a player object, the server device 10A configures at least one object of the plurality of objects as a target of a group, to which the player object belongs. As described above, the storage unit may store target configuration information where identification information of the object which is the target is mapped onto the group identification information. The configuring is executed for each of the player objects executing the predetermined motion.

Subsequently, the server device 10A executes the object generating process (Step S14). Specifically, the server device 10A generates a subsidiary object linking the target of each group newly configured in the process of Step S13 to each of the player objects belonging to each group. As described above, for example, the subsidiary object identification information may be configured in the target configuration information while being mapped onto the identification information of the object which is the target.

Thereafter, the server device 10A executes an image information generating process (Step S15). The server device 10A generates the object control information and the like, which are updated in the motion process of Step S11, as the image information. The server device 10A causes the image information to contain also subsidiary object information (for example, target configuration information). Thereafter, the server device 10A transmits the image information to the terminal device 20. The terminal device 20 which is a transmission destination is specified from the IP addresses, the user identification information, and the like which are received at the request for participation.

Subsequently, the server device 10A determines whether the game ends (Step S16). If the game is a group combat, the server device 10A may determine the ending of the game when ending conditions such as victory or defeat being confirmed are satisfied. When the game has not ended (Step S16: NO), the server device 10A returns to the process of Step S11. On the other hand, when the game has ended (Step S16: YES), the server device 10A ends the game progression process.

Until the game ends (Step S41: YES), the terminal device 20 outputs an image of the game space (displays an image of the game space on the display unit) based on the received image information (Step S40).

As described above, according to one aspect of the first embodiment, because the server device 10A includes at least the display control unit 11, the first configuration unit 12, the motion control unit 13, the second configuration unit 14, and the generation unit 15, the server device 10A generates a subsidiary object linking a target of a group to each of player objects belonging to the group. Therefore, a player can easily recognize other players' thoughts from the subsidiary objects. Moreover, because the target is configured and the subsidiary objects are generated based on the predetermined motion of a player object manipulated by the player, a manipulation of generating the subsidiary objects also becomes easy. Therefore, an improvement in convenience of a communication function in the game is obtained.

In the first embodiment, the server device 10A controls a progression of the game by executing the video game processing program; however, the present disclosure is not particularly limited to the configuration of the first embodiment. The game system may include, for example, a host terminal device and guest terminal devices illustrated in FIG. 4, and the host terminal device replacing the server device 10A may include at least the display control unit 11, the first configuration unit 12, the motion control unit 13, the second configuration unit 14, and the generation unit 15. Alternatively, a plurality of terminal devices may collaboratively control a progression of a game.

The plurality of terminal devices illustrated in FIG. 4 are connected to a peer to peer network. The host terminal device has various functions for providing information for controlling a progression of a video game for the guest terminal devices. Each of the terminal devices includes a manipulation device, a storage unit such as HDD, a control unit made up of a CPU and the like which executes the game and generates game images, and a display device displaying the game images. The storage unit of each terminal device stores software (video game execution program) for executing the video game.

The storage unit of the terminal device stores also software (video game processing program) for controlling the progression of the video game. That is, while executing the video game, each guest terminal device (control unit) executes the video game progression process based on the information for controlling the progression of the video game, which is sent from the host terminal device. While executing the video game, the host terminal device (control unit) generates and transmits the information (for example, image information) for controlling the progression of the video game to the guest terminal devices.

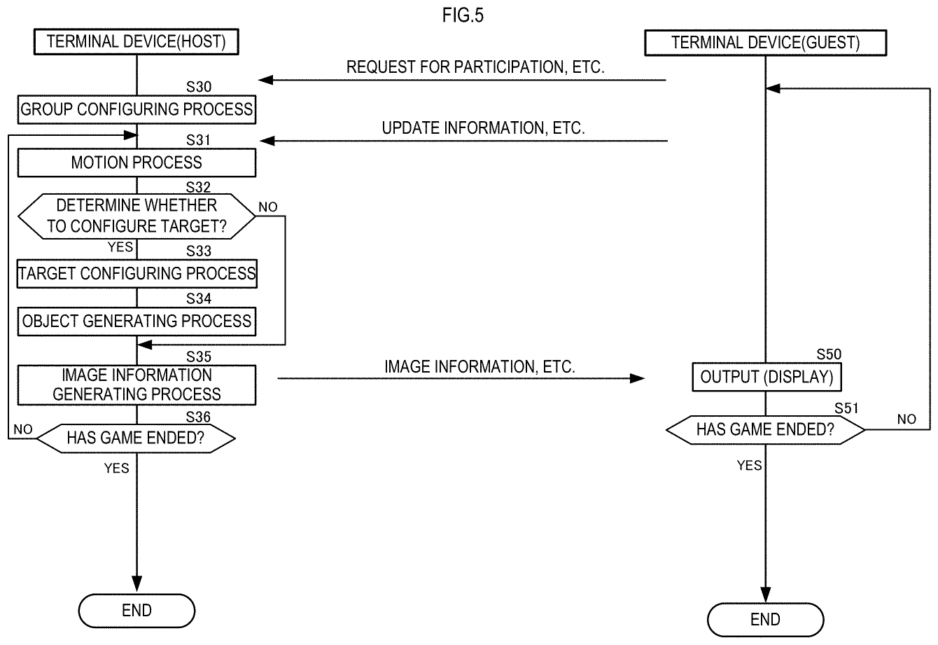

FIG. 5 is a flowchart illustrating an example of motions of the host terminal device and the guest terminal devices when the host terminal device executes the game progression process illustrated in FIG. 3.

In the progression process, the guest terminal devices transmit game participation request information to the host terminal device. The host terminal device may configure a lobby based on manipulation information of the manipulation unit generated by a player (user) of the host terminal device and wait for other players' requests for participation, which is not illustrated.

The host terminal device executes the group configuring process (Step S30). The host terminal device configures a group (team) for each of a plurality of objects containing a player object which is a configuration target of the group. The host terminal device configures also a group for a player object of the host terminal.

Thereafter, a game space is generated and the game starts. The guest terminal devices regularly transmit player object update information (manipulation information and the like) to the host terminal device. The host terminal device regularly acquires the manipulation information of the manipulation unit generated by the player (user) of the host terminal device.

The host terminal device executes a motion process of the objects in the game space (Step S31). As described above, the host terminal device causes at least a plurality of the objects to move, for which a group is configured, based on the player object update information and the like. The host terminal device causes also the player object of the host terminal to move based on the manipulation information. Therefore, object control information, for example, information on movements (positions) of the plurality of objects in the game space and action execution information, is updated.

Subsequently, the host terminal device determines whether to configure targets of the groups (Step S32). When it is determined that the configuring of the target is not required (Step S32: NO), the host terminal device proceeds to the process of Step S35. On the other hand, when it is determined that the configuring of the target is required (Step S32: YES), the host terminal device executes the target configuring process (Step S33).

Subsequently, the host terminal device executes the object generating process (Step S34). Specifically, the host terminal device generates a subsidiary object linking the target of each group newly configured in the process of Step S33 to each of the player objects belonging to each group. Subsequently, the host terminal device executes the image information generating process (Step S35). The host terminal device transmits the image information to the guest terminal devices.

Subsequently, the host terminal device determines whether the game ends (Step S36). When the game has not ended (Step S36: NO), the host terminal device returns to the process of Step S31. On the other hand, when the game has ended (Step S36: YES), the host terminal device ends the game progression process.

Until the game ends (Step S51: YES), the guest terminal devices output an image of the game space (display an image of the game space on the display units) based on the received image information (Step S50). The host terminal device also displays an image on the display unit based on the generated image information.

In the embodiment, a target of a group which is configured by a predetermined motion executed once is one object; however, the present disclosure is not particularly limited to the configuration of the embodiment. The present disclosure may have a configuration where a plurality of objects are configured as a target of a group by the predetermined motion executed once.

The group may be configured at any time before a motion of a player object in the game space starts.

The “player object” of any form may be adopted if the player object is an object that can be manipulated by a player. Various objects, for example, an imaginary card illustrated by a character, a character, an avatar, and a fighter aircraft, correspond to the “player object”.

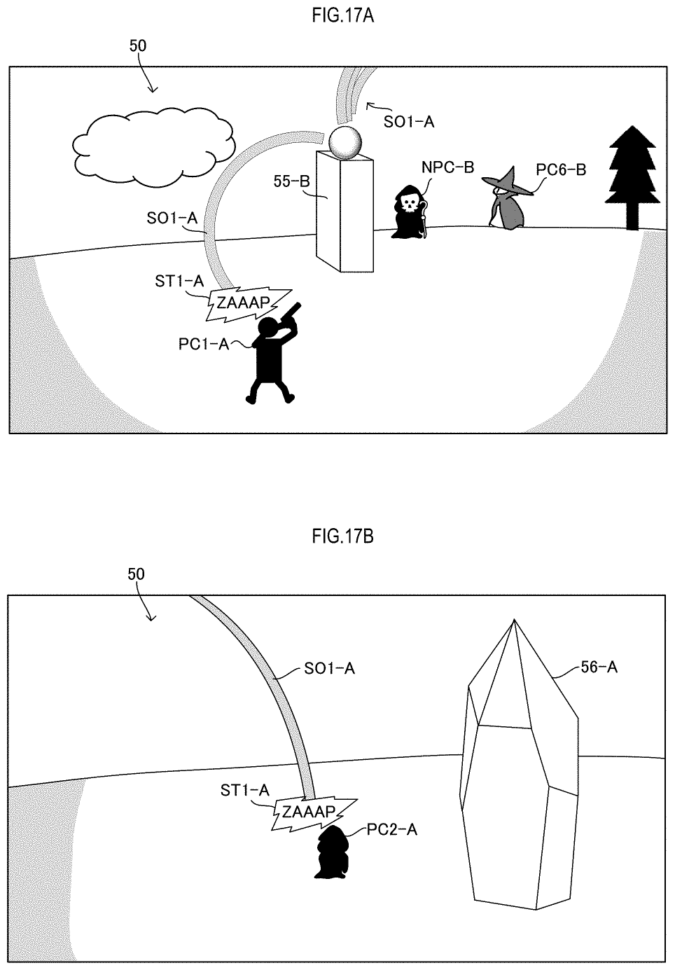

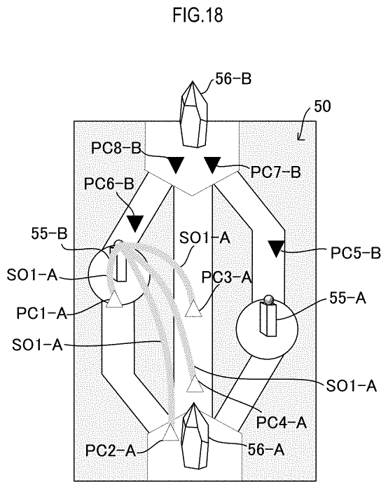

The “subsidiary object” of any configuration may be adopted if the subsidiary object links a target of a group to each of player objects belonging to the group. Objects (subsidiary objects SO) of curves illustrated in FIGS. 17A and 17B and 18 may be adopted, for example. A player may be able to recognize that a target of a group is mapped onto player objects belonging to the group via the subsidiary object, and the target may not be completely connected with the player objects via the subsidiary object.

It is possible to arbitrarily configure the number of targets which can be configured per group. One target may be configured per group. In this case, when a target is already configured, even though a predetermined motion is newly executed by a player object, the configuring of a target may not be received. When the predetermined motion is newly executed by a player object, the configuring may be executed such that the target is changed. Alternatively, a manipulation of cancelling the target may be received. In this case, a cancellation manipulation from only a player executing the predetermined motion may be received.

When a predetermined condition is established, the configuring of the target may be released. The predetermined condition implies a condition where a targeted object has become extinct, or a case where a predetermined time has elapsed from the point of configuring the target.

If groups are formed by a plurality of objects, the “game” of any genre may be adopted, for example, a combat game, a role-playing game, or a breeding game may be adopted.

The “game space” may be either a 2D (dimensional) virtual space or a 3D (dimensional) virtual space. An image captured by a virtual camera is displayed on the display unit of the terminal device as an image of the game space. Each of the terminal devices 20 and 201 to 20N may generate part of the game space containing a player object of the terminal device as an image based on object control information and the like, and display the image on the display unit. In this case, if subsidiary objects are within an imaging range of the virtual camera, the subsidiary objects are also displayed. Because images are generated in a typical manner by the virtual camera, a detailed description thereof will be omitted.

### Second Embodiment

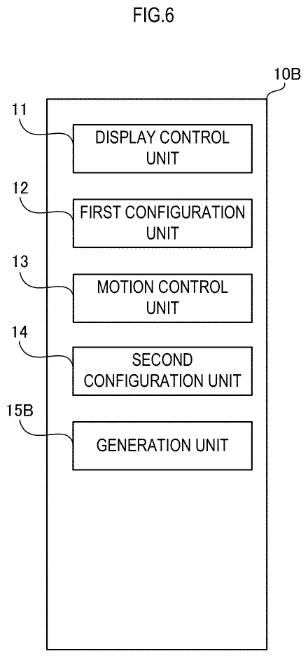

FIG. 6 is a block diagram illustrating a configuration of a server device 10B, which is an example of the configuration of the server device 10. In the embodiment, the server device 10B includes at least the display control unit 11, the first configuration unit 12, the motion control unit 13, the second configuration unit 14, and a generation unit 15B.

The display control unit 11 displays an image (game image) of a game space on a display unit of each of the plurality of terminal devices 20 and 201 to 20N. The first configuration unit 12 configures a group to which each of a plurality of the objects belongs. The motion control unit 13 controls motions (actions) of the plurality of objects. The second configuration unit 14 configures at least one object of the plurality of objects as a target of a group, to which player objects belong, based on a predetermined motion executed by the player objects.

The generation unit 15B generates a subsidiary object linking a target of a group to each of player objects belonging to the group. The generation unit 15B of the embodiment generates subsidiary objects in response to a relationship between a group, to which an object belongs which is a target of a group, and the group having the object as a target. That is, subsidiary objects of types in response to the relationship are generated. Generated subsidiary objects differ, for example, between when the relationship is a hostile relationship (opponent) and when two groups are the same group. The generation unit 15B generates subsidiary objects with reference to, for example, data where the relationship is mapped onto the types of subsidiary objects prestored in the storage unit.

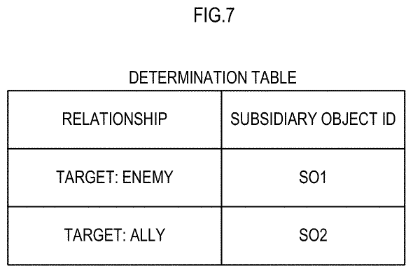

In a description of an example hereinbelow, in a team-to-team combat game, two types of subsidiary objects illustrated in FIG. 7 are used. FIG. 7 illustrates an example of a determination table for determining subsidiary objects. The determination table includes a relationship field and a subsidiary object ID field. The determination table may be contained in game data.

Information indicating the relationship is configured in the relationship field. Specifically, information for specifying whether a target is an enemy or an ally is configured. Subsidiary object identification information is configured in the subsidiary object ID field. When the relationship indicates “target: enemy” (target belongs to an opposite team), a subsidiary object of “object ID: SO1” is generated. When the relationship indicates “target: ally” (target belongs to an ally team), a subsidiary object of “object ID: SO2” is generated. The subsidiary objects of two types may be objects having the same shape but different colors.

The generation unit 15B generates subsidiary objects in such a manner that subsidiary object identification information is stored in the storage unit of the server device 10B while being mapped onto target configuration information.

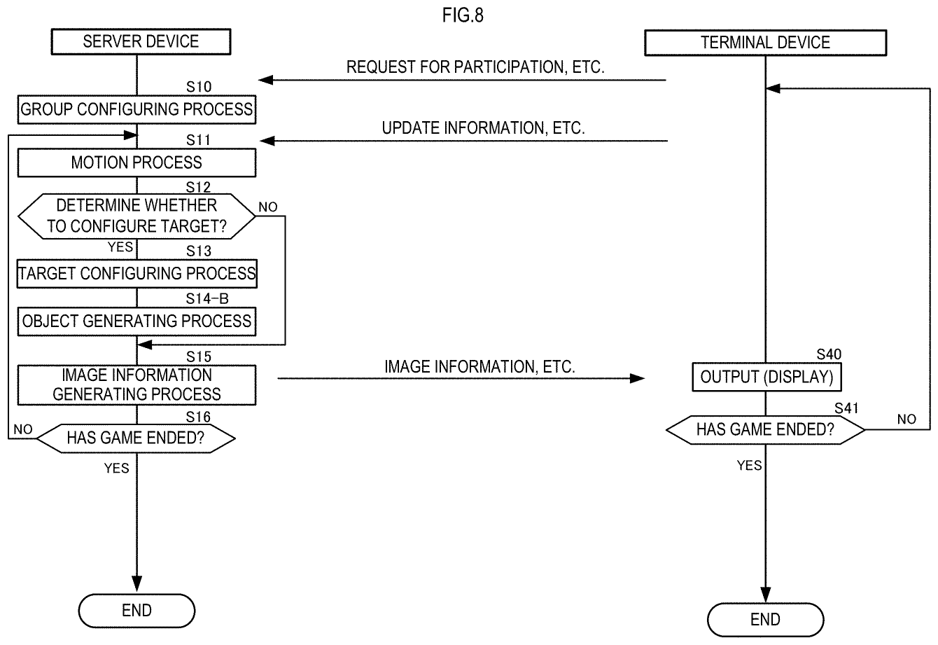

FIG. 8 is a flowchart illustrating an example of a progression process of a game which is executed by the system 100. In the progression process of the embodiment, a game progression process containing a group configuring process, a group target configuring process, and a subsidiary object generating process is executed. In FIG. 8, the group configuring process, the group target configuring process, the subsidiary object generating process will be mainly described, and part of other processes will be omitted. In a description of an example hereinbelow, the server device 10B and the terminal device 20 execute the progression process. A description of the flowchart illustrating the motion of the host terminal device will be omitted from the viewpoint of avoiding the duplication of the description.

The progression process of the embodiment is executed in response to the occasion that a player generates a manipulation input for requesting game participation.

In the progression process, the terminal device 20 transmits game participation request information to the server device 10B. The server device 10B executes the group configuring process (Step S10). Thereafter, a game space is generated and the game starts. The terminal device 20 regularly transmits player object update information to the server device 10B.

The server device 10B executes a motion process the objects in the game space (Step S11). Subsequently, the server device 10B determines whether to configure targets of groups (Step S12). When it is determined that the configuring of the target is not required (Step S12: NO), the server device 10B proceeds to the process of Step S15. On the other hand, when it is determined that the configuring of the target is required (Step S12: YES), the server device 10B executes the target configuring process (Step S13).

Subsequently, the server device 10B executes the object generating process (Step S14-B). Specifically, the server device 10B generates a subsidiary object linking the target of each group newly configured in the process of Step S13 to each of the player objects belonging to each group. The server device 10B of the embodiment determines the relationship. The server device 10B generates subsidiary objects in response to the determined relationship. As described above, for example, the server device 10B may configure the subsidiary object identification information in the target configuration information while the subsidiary object identification information is mapped onto the identification information of the object which is the target.

Thereafter, the server device 10B executes the image information generating process (Step S15). The server device 10B transmits image information to the terminal device 20. Subsequently, the server device 10B determines whether the game ends (Step S16). When the game has not ended (Step S16: NO), the server device 10B returns to the process of Step S11. On the other hand, when the game has ended (Step S16: YES), the server device 10B ends the game progression process.

Until the game ends (Step S41: YES), the terminal device 20 outputs an image of the game space (displays an image of the game space on the display unit) based on the received image information (Step S40).

As described above, according to one aspect of the second embodiment, because the server device 10B includes at least the display control unit 11, the first configuration unit 12, the motion control unit 13, the second configuration unit 14, and the generation unit 15B, the server device 10B generates a subsidiary object linking a target of a group to each of player objects belonging to the group. Therefore, a player can easily recognize other players' thoughts from the subsidiary objects. Moreover, because the target is configured and the subsidiary objects are generated based on the predetermined motion of a player object manipulated by the player, a manipulation of generating the subsidiary objects also becomes easy. Therefore, an improvement in convenience of a communication function in the game is obtained.

Because subsidiary objects are generated in response to the relationship between a group, to which an object belongs which is a target of a group, and the group having the object as a target, a player can more easily recognize other players' thoughts from each subsidiary object. Therefore, a higher improvement in convenience of the communication function is obtained.

In the embodiment described above, two types of subsidiary objects are exemplified; however, the types of subsidiary objects are not limited to two types.

### Third Embodiment

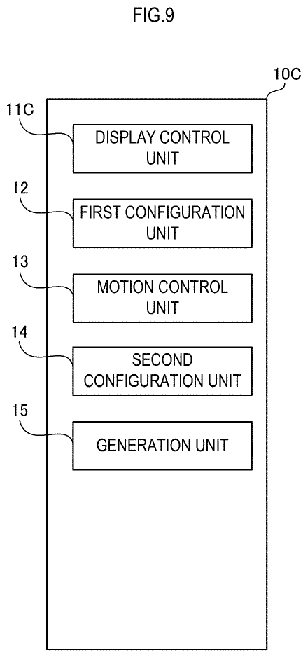

FIG. 9 is a block diagram illustrating a configuration of a server device 10C, which is an example of the configuration of the server device 10. In the embodiment, the server device 10C includes at least a display control unit 11C, the first configuration unit 12, the motion control unit 13, the second configuration unit 14, and the generation unit 15.

The display control unit 11C displays an image (game image) of a game space on the display unit of each of the plurality of terminal devices 20 and 201 to 20N. In the embodiment, the display control unit 11C selects a terminal device which is to display subsidiary objects. For example, even in an image of the same game space, a terminal device may display subsidiary objects, and other terminal devices may not display subsidiary objects.

The display control unit 11C performs control such that a subsidiary object of a target of a group is displayed on a terminal device of a player object belonging to the group. Therefore, a player can see subsidiary objects related to a group to which a player object, which is manipulated by the player himself or herself, belongs, but cannot see subsidiary objects related to other groups. As a result, for example, in a combat between groups of teams, a target of a player's own group is not specified to players of other opposite groups.

The display control unit 11C controls display of subsidiary objects, for example, by changing subsidiary object information, which is to be transmitted, for each of the terminal devices 20 and 201 to 20N. Alternatively, instead of the subsidiary object information (to be transmitted to each of the terminal devices 20 and 201 to 20N) being changed, the terminal devices 20 and 201 to 20N may control display and non-display of subsidiary objects. In this case, when with reference to object control information, subsidiary object information (for example, target configuration information), and the like, each of the terminal devices 20 and 201 to 20N is determined to belong to the same group to which a player object of the terminal device belongs, each of the terminal devices 20 and 201 to 20N may display a subsidiary object.

The first configuration unit 12 configures a group to which each of a plurality of the objects belongs. The motion control unit 13 controls motions (actions) of the plurality of objects. The second configuration unit 14 configures at least one object of the plurality of objects as a target of a group, to which player objects belong, based on a predetermined motion executed by the player objects. The generation unit 15 generates a subsidiary object linking a target of a group to each of player objects belonging to the group.

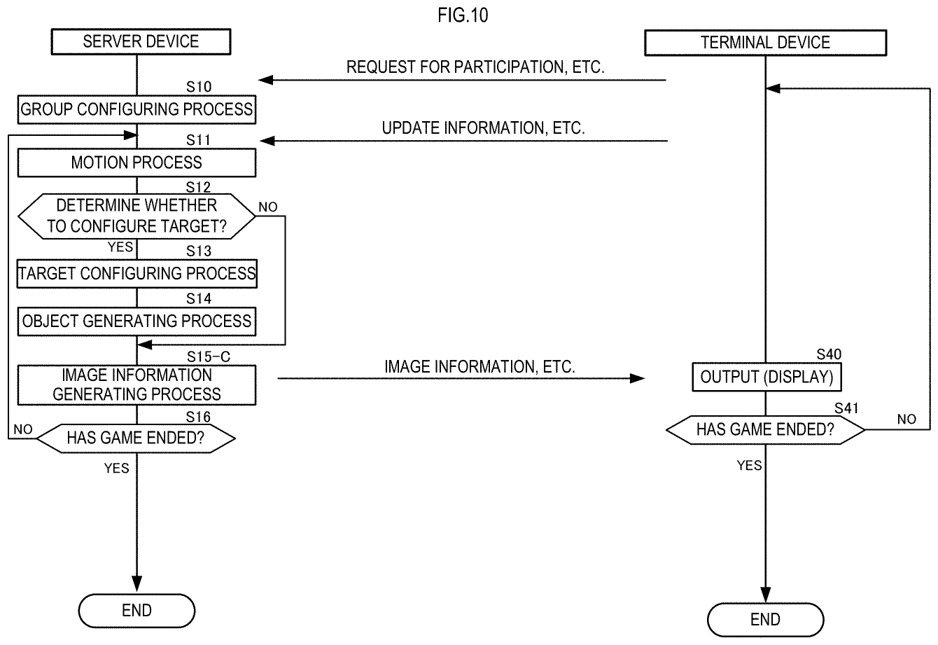

FIG. 10 is a flowchart illustrating an example of a progression process of a game which is executed by the system 100. In the progression process of the embodiment, a game progression process containing a group configuring process, a group target configuring process, and a subsidiary object generating process is executed. In FIG. 10, the group configuring process, the group target configuring process, the subsidiary object generating process will be mainly described, and part of other processes will be omitted. In a description of an example hereinbelow, the server device 10C and the terminal device 20 execute the progression process. A description of the flowchart illustrating the motion of the host terminal device will be omitted from the viewpoint of avoiding the duplication of the description.

The progression process of the embodiment is executed, for example, in response to the occasion that a player generates a manipulation input for requesting game participation.

In the progression process, the terminal device 20 transmits game participation request information to the server device 10C. The server device 10C executes the group configuring process (Step S10). Thereafter, a game space is generated and the game starts. The terminal device 20 regularly transmits player object update information to the server device 10C.

The server device 10C executes a motion process of the objects in the game space (Step S11). Subsequently, the server device 10C determines whether to configure targets of groups (Step S12). When it is determined that the configuring of the target is not required (Step S12: NO), the server device 10C proceeds to the process of Step S15. On the other hand, when it is determined that the configuring of the target is required (Step S12: YES), the server device 10C executes the target configuring process (Step S13).

Subsequently, the server device 10C executes the object generating process (Step S14). Specifically, the server device 10C generates a subsidiary object linking the target of each group newly configured in the process of Step S13 to each of the player objects belonging to each group.

Thereafter, the server device 10C executes the image information generating process (Step S15-C). The server device 10C generates the object control information and the like, which are updated in the motion process of Step S11, as the image information. The server device 10C generates subsidiary object information (for example, target configuration information) for each terminal device, and causes the image information for each terminal device to contain the subsidiary object information. Alternatively, as described above, the terminal devices may generate common image information. The server device 10C transmits the image information to the terminal device 20.

Subsequently, the server device 10C determines whether the game ends (Step S16). When the game has not ended (Step S16: NO), the server device 10C returns to the process of Step S11. On the other hand, when the game has ended (Step S16: YES), the server device 10C ends the game progression process.

Until the game ends (Step S41: YES), the terminal device 20 outputs an image of the game space (displays an image of the game space on the display unit) based on the received image information (Step S40). The terminal device 20 displays subsidiary objects of a group to which a player object of the terminal device 20 belongs.

As described above, according to one aspect of the third embodiment, because the server device 10C includes at least the display control unit 11C, the first configuration unit 12, the motion control unit 13, the second configuration unit 14, and the generation unit 15, the server device 10C generates a subsidiary object linking a target of a group to each of player objects belonging to the group. Therefore, a player can easily recognize other players' thoughts from the subsidiary objects. Moreover, because the target is configured and the subsidiary objects are generated based on the predetermined motion of a player object manipulated by the player, a manipulation of generating the subsidiary objects also becomes easy. Therefore, an improvement in convenience of a communication function in the game is obtained.

A subsidiary object for a target of a group is displayed on a terminal device for a player object belonging to the group. Therefore, it is possible to prevent contents, for example, combat strategy of communication within a group from being specified to player objects (players) of other groups. Therefore, a higher improvement in convenience of the communication function is obtained.

Also in the embodiment, as illustrated in the second embodiment, subsidiary objects may be generated in response to the relationship between a group, to which an object belongs which is a target of a group, and the group having the object as a target.

### Fourth Embodiment

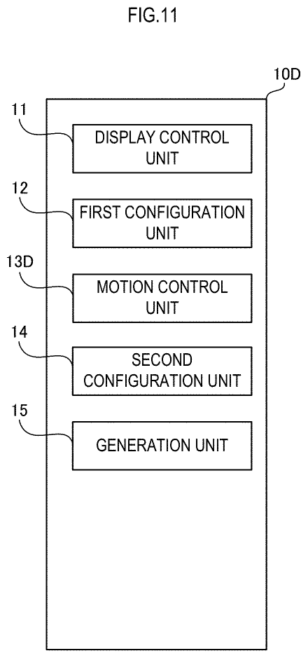

FIG. 11 is a block diagram illustrating a configuration of a server device 10D, which is an example of the configuration of the server device 10. In the embodiment, the server device 10D includes at least the display control unit 11, the first configuration unit 12, a motion control unit 13D, the second configuration unit 14, and the generation unit 15.

The display control unit 11 displays an image (game image) of a game space on the display unit of each of the plurality of terminal devices 20 and 201 to 20N. The first configuration unit 12 configures a group to which each of a plurality of the objects belongs.

The motion control unit 13D controls motions (actions) of the plurality of objects. When a player object enters a predetermined state in response to an occasion of being attacked by other objects, the motion control unit 13D of the embodiment restricts part of motions of the player object. Part of motions implies part of all the motions executable by the player object, and corresponds to motions such as attack, defense, reclaiming, and escape. In the embodiment, part of motions does not contain a movement and predetermined motions. That is, a player object can execute at least a movement and the predetermined motions even though the player object is in the predetermined state.

The predetermined state corresponds to a combat-disable state where a current value of a vital power (HP) which is a parameter of a player object reaches a predetermined value (HP=0). In this case, the motion control unit 13D updates (decreases) a current value of a vital power of each player object in response to a received attack. When the motion control unit 13D receives information on the manipulation of each player object from each of the terminal devices 20 and 201 to 20N as update information, the motion control unit 13D does not execute motions of player objects in a combat-disable state if the motions are restricted motions.

When a motion of a player object manipulated by a player is executed in a terminal device used by the player, the motion control unit 13D only may configure, for example, either a combat-able (normal) state or a combat-disable state as state information. The server device 10D transmits the state information to the terminal devices 20 and 201 to 20N. The terminal devices 20 and 201 to 20N restricts the execution of part of motions of corresponding player objects based on the state information. In the example, a current value of a vital power may be transmitted as the state information.

The second configuration unit 14 configures at least one object of the plurality of objects as a target of a group, to which player objects belong, based on a predetermined motion executed by the player objects. The generation unit 15 generates a subsidiary object linking a target of a group to each of player objects belonging to the group.

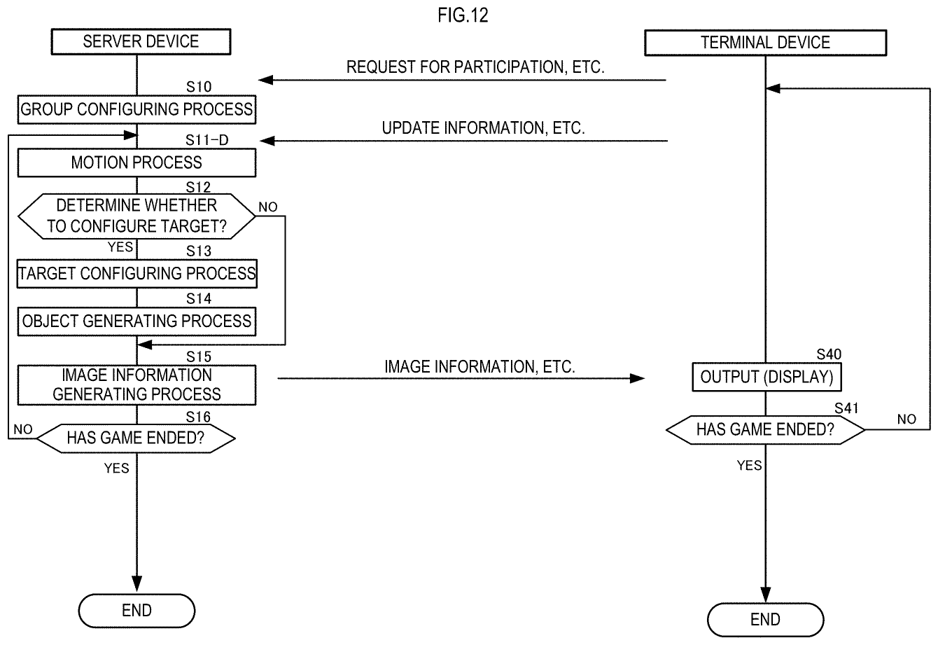

FIG. 12 is a flowchart illustrating an example of a progression process of a game which is executed by the system 100. In the progression process of the embodiment, a game progression process containing a group configuring process, a group target configuring process, and a subsidiary object generating process is executed. In FIG. 12, the group configuring process, the group target configuring process, the subsidiary object generating process will be mainly described, and part of other processes will be omitted. In a description of an example hereinbelow, the server device 10D and the terminal device 20 execute the progression process. A description of the flowchart illustrating the motion of the host terminal device will be omitted from the viewpoint of avoiding the duplication of the description.

The progression process of the embodiment is executed in response to the occasion that a player generates a manipulation input for requesting game participation.

In the progression process, the terminal device 20 transmits game participation request information to the server device 10D. The server device 10D executes the group configuring process (Step S10). Thereafter, a game space is generated and the game starts. The terminal device 20 regularly transmits player object update information to the server device 10D.

The server device 10D executes a motion process of the objects in the game space (Step S11-D). The server device 10D causes at least a plurality of the objects to move based on the player object update information and the like. When a motion of each player object is determined to be a restricted motion based on a current value of a vital power, the server device 10D does not execute the motion. As described above, the server device 10D updates also the current value of the vital power of each player object in response to a received attack. Therefore, object control information of the plurality of objects (containing the player object) in the game space, for example, information on movements (positions) and action execution information, is updated.

Subsequently, the server device 10D determines whether to configure targets of groups (Step S12). When it is determined that the configuring of the target is not required (Step S12: NO), the server device 10D proceeds to the process of Step S15. On the other hand, when it is determined that the configuring of the target is required (Step S12: YES), the server device 10D executes the targets (Step S13).

Subsequently, the server device 10D executes the object generating process (Step S14). Specifically, the server device 10D generates a subsidiary object linking the target of each group newly configured in the process of Step S13 to each of the player objects belonging to each group.

Thereafter, the server device 10D executes the image information generating process (Step S15). The server device 10D generates the object control information and the like, which are updated in the motion process of Step S11-D, as the image information. The server device 10D causes the image information to contain subsidiary object information (for example, target configuration information). As described above, when a motion of a player object manipulated by a player is executed in a terminal device used by the player, the state information may be transmitted to the terminal devices 20 and 201 to 20N.

The server device 10D transmits the image information to the terminal device 20. Subsequently, the server device 10D determines whether the game ends (Step S16). When the game has not ended (Step S16: NO), the server device 10D returns to the process of Step S11. On the other hand, when the game has ended (Step S16: YES), the server device 10D ends the game progression process.

Until the game ends (Step S41: YES), the terminal device 20 outputs an image of the game space (displays an image of the game space on the display unit) based on the received image information (Step S40).

As described above, according to one aspect of the fourth embodiment, because the server device 10D includes at least the display control unit 11, the first configuration unit 12, the motion control unit 13D, the second configuration unit 14, and the generation unit 15, the server device 10D generates a subsidiary object linking a target of a group to each of player objects belonging to the group. Therefore, a player can easily recognize other players' thoughts from the subsidiary objects. Moreover, because the target is configured and the subsidiary objects are generated based on the predetermined motion of a player object manipulated by the player, a manipulation of generating the subsidiary objects also becomes easy. Therefore, an improvement in convenience of a communication function in the game is obtained.

Even though a player object is in the predetermined state, because a movement and the predetermined motions are not restricted, the communication function operates even in the predetermined state. Therefore, even though the player object is a player inexperienced in the game, for example, a beginner who is likely to enter the predetermined state, the player object can support other players via communication within at least the group.

In the embodiment, when a recovery condition is established, a player object may recover from the predetermined state to the normal state. The recovery condition implies that a predetermined recovery time has elapsed from the point of entering the predetermined state, or that other player objects execute a recovery motion on a player object in the predetermined state.

Also in the embodiment, as illustrated in the second embodiment, subsidiary objects may be generated in response to the relationship between a group, to which an object belongs which is a target of a group, and the group having the object as a target.

Also in the embodiment, as illustrated in the third embodiment, a subsidiary object of a target of a group may be displayed on a terminal device of a player object belonging to the group.

### Fifth Embodiment

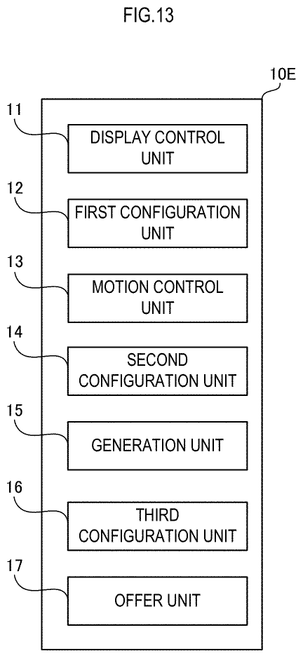

FIG. 13 is a block diagram illustrating a configuration of a server device 10E, which is an example of the configuration of the server device 10. In the embodiment, the server device 10E includes at least the display control unit 11, the first configuration unit 12, the motion control unit 13, the second configuration unit 14, the generation unit 15, a third configuration unit 16, and an offer unit 17.

The display control unit 11 displays an image (game image) of a game space on the display unit of each of the plurality of terminal devices 20 and 201 to 20N. The first configuration unit 12 configures a group to which each of a plurality of the objects belongs. The motion control unit 13 controls motions (actions) of the plurality of objects.

The second configuration unit 14 configures at least one object of the plurality of objects as a target of a group, to which player objects belong, based on a predetermined motion executed by the player objects. The generation unit 15 generates a subsidiary object linking a target of a group to each of player objects belonging to the group.

When a target of a group is configured, the third configuration unit (third configuration function) 16 configures a sub-task for the group based on the target. The third configuration unit 16 may instruct the storage unit of the server device 10E to store (configure) that the sub-task is being executed (configured). A task implies an item that has to be accomplished in a game. In the embodiment, the sub-task related to the target is configured. Even though not being accomplished, the sub-task does not affect a progression of the game. Task contents (clear condition) of the sub-task may be contained in game data in advance.

When the sub-task has been accomplished, the offer unit 17 (offer function 17) offers a reward to a group which has made the accomplishment or player objects (players) belonging to the group. The reward is not limited to specific forms if the reward can help players to advantageously play the game. Reward points are used (consumed) to increase a parameter such as movement speed of a player object. The offer implies that a group or a player object (player) enters a state of being able to use the reward. For example, when reward points are offered to a group, the reward points may be stored as a useable reward in the storage unit of the server device 10E while being mapped onto group identification information. When reward points are offered to player objects (players), the reward points may be stored as a useable reward in the storage unit of the server device 10E while being mapped onto player object identification information (player identification information). Rewards may be contained in the game data while being mapped onto the task contents of the sub-task.

When rewards are offered to a group, for example, the rewards may be accumulated and stored during the execution of the game, and the sum of the rewards may be equally distributed to player objects (players) belonging to the group at the end of the game. Alternatively, the offered rewards may be useable during the execution of the game. A parameter such as defense power of all objects belonging to a group is increased by using (consuming) reward points offered to the group.

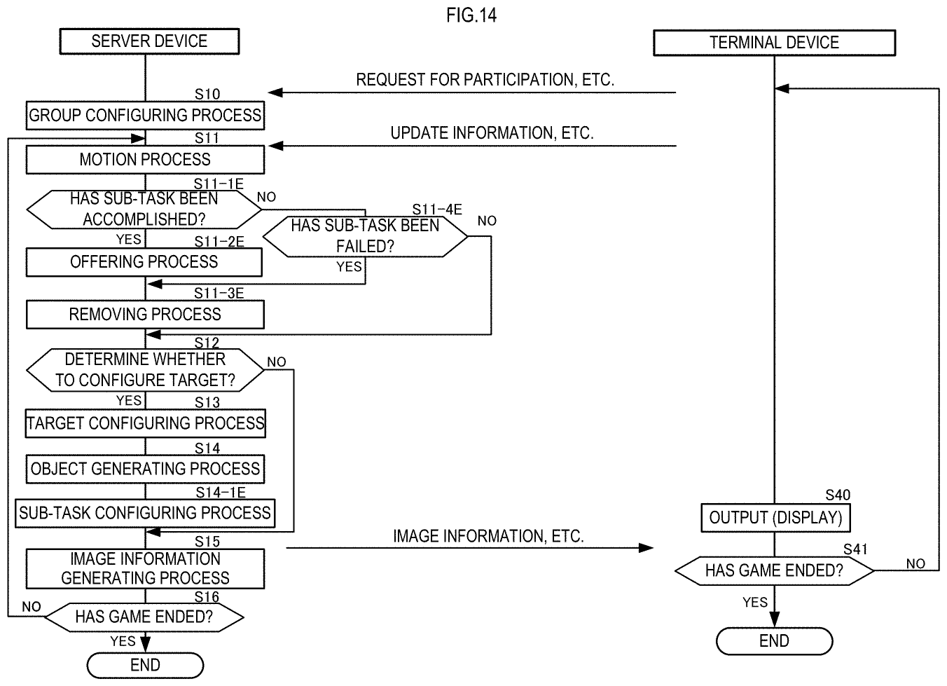

FIG. 14 is a flowchart illustrating an example of a progression process of a game which is executed by the system 100. In the progression process of the embodiment, a game progression process containing a group configuring process, a group target configuring process, and a subsidiary object generating process is executed. In FIG. 14, the group configuring process, the group target configuring process, the subsidiary object generating process will be mainly described, and part of other processes will be omitted. In a description of an example hereinbelow, the server device 10E and the terminal device 20 execute the progression process. A description of the flowchart illustrating the motion of the host terminal device will be omitted from the viewpoint of avoiding the duplication of the description.

The progression process of the embodiment is executed in response to the occasion that a player generates a manipulation input for requesting game participation.

In the progression process, the terminal device 20 transmits game participation request information to the server device 10E. The server device 10E executes the group configuring process (Step S10). Thereafter, a game space is generated and the game starts. The terminal device 20 regularly transmits player object update information to the server device 10E.

The server device 10E executes a motion process the objects in the game space (Step S11). Thereafter, the server device 10E determines if there are accomplished sub-tasks under configuration (Step S11-1E). As described above, with reference to task contents (clear condition) of sub-tasks, updated object states, and the like, the server device 10E determines whether sub-tasks have been accomplished. The server device 10E makes determinations on all the sub-tasks.

When there are the accomplished sub-tasks under configuration (Step S11-1E: YES), the server device 10E executes a reward offering process (Step S11-2E). As described above, the server device 10E offers rewards to a group that has accomplished the sub-tasks. The server device 10E removes (erases) information on the accomplished sub-tasks from the storage unit (Step S11-3E). Thereafter, the server device 10E proceeds to the process of Step S12.

When there are no accomplished sub-tasks under configuration (Step S11-1E: NO), the server device 10E determines whether there are failed sub-tasks under configuration (Step S11-4E). When there are no failed sub-tasks under configuration (Step S11-4E: NO), the server device 10E proceeds to the process of Step S12. On the other hand, when there are the failed sub-tasks under configuration (Step S11-4E: YES), the server device 10E removes (erases) information on the failed sub-tasks from the storage unit (Step S11-3E).

Subsequently, the server device 10E determines whether to configure targets of groups (Step S12). When it is determined that the configuring of the target is not required (Step S12: NO), the server device 10E proceeds to the process of Step S16. On the other hand, when it is determined that the configuring of the target is required (Step S12: YES), the server device 10E configures the targets (Step S13).

Subsequently, the server device 10E executes the object generating process (Step S14). Specifically, the server device 10E generates a subsidiary object linking the target of each group newly configured in the process of Step S13 to each of the player objects belonging to each group.

The server device 10E executes a sub-task configuring process (Step S14-1E). As described above, the server device 10E configures sub-tasks.

Thereafter, the server device 10E executes the image information generating process (Step S15). The server device 10E transmits image information to the terminal device 20. Subsequently, the server device 10E determines whether the game ends (Step S16). When the game has not ended (Step S16: NO), the server device 10E returns to the process of Step S11. On the other hand, when the game has ended (Step S16: YES), the server device 10E ends the game progression process. When it is determined that the game has ended, the server device 10E may distribute, for example, rewards, which are offered to a group, to player objects belonging to the group.

Until the game ends (Step S41: YES), the terminal device 20 outputs an image of the game space (displays an image of the game space on the display unit) based on the received image information (Step S40).

As described above, according to one aspect of the fifth embodiment, because the server device 10E includes at least the display control unit 11, the first configuration unit 12, the motion control unit 13, the second configuration unit 14, and the generation unit 15, the third configuration unit 16, and the offer unit 17, the server device 10E generates a subsidiary object linking a target of a group to each of player objects belonging to the group. Therefore, a player can easily recognize other players' thoughts from the subsidiary objects. Moreover, because the target is configured and the subsidiary objects are generated based on the predetermined motion of a player object manipulated by the player, a manipulation of generating the subsidiary objects also becomes easy. Therefore, an improvement in convenience of a communication function in the game is obtained.

Because sub-tasks are configured for a group by configuring a target of the group, an interest in the game improves.

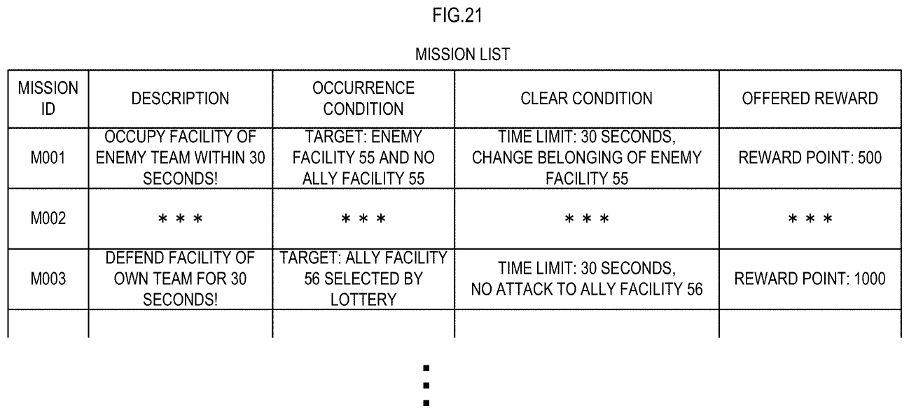

The sub-tasks of various components can be adopted. For example, in a combat between groups of teams, if a targeted object belongs to an opposite group, a sub-task implies that the target is brought into the combat-disable state within a time limit (for example, 30 seconds). The being brought into the combat-disable state corresponds to the clear condition (sub-task accomplishment condition). If a targeted object belongs to an ally group, a sub-task implies that the target is defended from attack until a time limit (for example, 30 seconds) has elapsed. When there are plural types of sub-tasks, game data may contain information in which a clear condition and an offered reward are mapped onto sub-task identification information (for example, refer to the mission list illustrated in FIG. 21). The sub-task may be selected to correspond to each target.

When the configuration of a target is released, the sub-task of the embodiment may end forcibly. The configuration of the target may be released when the corresponding sub-task ends (configuration release).

Also in the embodiment, the configurations illustrated in the second to fourth embodiments may be applied.

### Sixth Embodiment

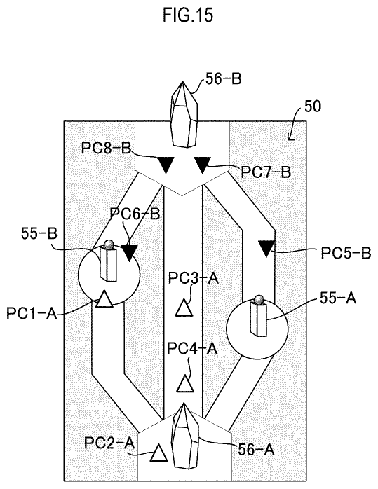

FIG. 15 is a schematic view illustrating a game space 50 of a game, the progression of which is controlled by a server device 10F which is an example of the configuration of the server device 10. In the game of the embodiment, a combat between groups of teams is executed in the game space (3D virtual game space) 50 illustrated in FIG. 15. Four player characters (player objects) PC belong to one team. When eight players participate in the game, the game starts (play starts), and when victory or defeat is determined, the game ends (play ends). A player instructs a player's own player character PC to execute a motion via the manipulation unit of the player's own terminal device.

The game space 50 contains objects such as a non-player character NPC and facilities 55 and 56 in addition to the player objects PC. In the embodiment, teams (groups) are configured for also the non-player character NPC and the facilities 55 and 56 in addition to the player character PC.

In the game space 50 illustrated in FIG. 15, player characters PC1-A to PC4-A and facilities 55-A and 56-A belong to a team A. Player characters PC5-B to PC8-B and facilities 55-B and 56-B belong to a team B. The server device 10F, for example, randomly configures belonging teams for the player characters PC. Initially, one facility 55 and one facility 56 are configured for each team. In FIG. 15, the forms of the player characters PC are illustrated in a simplified manner.

The non-player characters NPC regularly appear from the facilities 55-A and 55-B. A non-player character NPC-A belonging to the team A appears from the facility 55-A belonging to the team A. A non-player character NPC-B belonging to the team B appears from the facility 55-B belonging to the team B. The non-player character NPC is not illustrated in FIG. 15.

In the embodiment, when the facility 55 is occupied (attacked) by the player character PC of an enemy team, a team to which the facility 55 belongs is changed. When the facility 55 is attacked by the player character PC of the enemy team, a current value of a vital power (HP) of the facility 55 decreases. When the vital power reaches the predetermined value (HP=0), the team to which the facility 55 belongs is changed from the current team to the enemy team. Therefore, the player character PC is also required to defend the facility 55 of the player character's own team such that the facility 55 is not lost to the enemy team.

The facility 56 is a target for attack from the enemy team. If the facility 56 is attacked by the enemy team, a current value of a vital power (team HP) of the team decreases. Because the facility 56 has no defense function, the player characters PC of the same team are required to defend the facility 56.

The facility 56 becomes a revival point (respawn point) for the player characters PC of the same team. If any of the player character PC is attacked by the player character PC of the enemy team, a current value of a vital power (HP) of the character decreases. If the current value reaches the predetermined value (HP=0), the player character PC enters the combat-disable state. In the embodiment, there is no change to the team to which the facility 56 belongs.

When the player character PC has entered the combat-disable state, motions (attack, defense, and recovery) of the player character PC are prohibited. The combat-disable state is released after a recovery time (for example, 10 seconds) has elapsed. After the release, a current value of a vital power of the player character PC recovers to an initial value, and the player character PC is redisposed at the facility 56. Even though the player character PC in the combat-disable state is attacked by the enemy team, a current value of a vital power of the player character PC does not change.

In the embodiment, when the player character PC of the enemy team and the facility 56 of the enemy team are attacked, a current value of a vital power (team HP) of the enemy team can decrease. When the current value of the vital power of the enemy team reaches a predetermined value (team HP=0), a victory of the player's own team is determined.

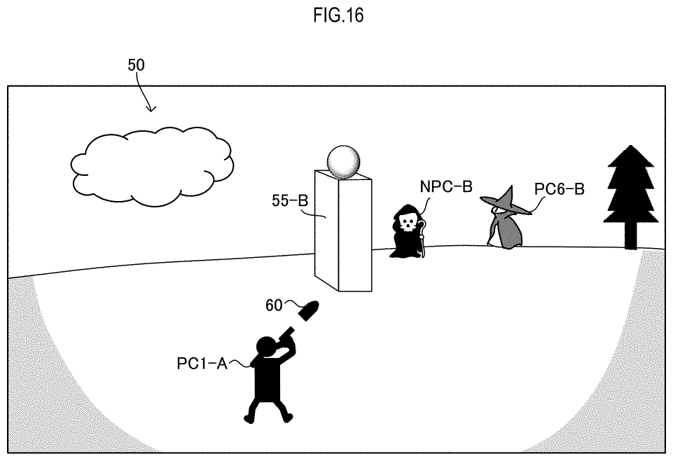

An image (game image) of the game space 50, which is captured by the virtual camera, is displayed on the display unit of each of the terminal devices 20 and 201 to 20N of players. In the embodiment, as illustrated in FIG. 16, part of the game space 50 is displayed in such a manner that the player character PC (PC-1A) manipulated by a player of a terminal device is centered therein. FIG. 16 is an example of an image displayed on the terminal device of the player manipulating the player character PC1-A.

In the embodiment, the player character PC can execute target shooting in addition to motions such as movement, attack, defense, and recovery. The target shooting is a motion for a player to deliver his or her own intention (battle strategy) to other players of his or her own team.

A moving body 60 (moving body object 60) such as bullets can be shot at objects such as other player characters PC, the non-player character NPC, and the facilities 55 and 56 via the target shooting. If an object is hit by the moving body 60, the hit object is configured as a target of a team to which the player character PC, which has executed the target shooting, belongs.

When the target of the team is configured, the subsidiary objects SO are also generated to link the target to each of the player objects PC belonging to the group. The subsidiary object SO is an object of curve (line segment). FIGS. 17A and 17B illustrate a subsidiary object SO1-A which is one of the subsidiary objects SO. FIG. 17A is an example of an image displayed on the terminal device of the player manipulating the player character PC1-A. FIG. 17B is an example of an image displayed on a terminal device of a player manipulating the player character PC2-A.

An object for a stamp ST is generated at an end of the subsidiary object SO, which is on the side of the player character PC. FIGS. 17A and 17B illustrate a stamp ST1-A which is one of the stamps ST. FIG. 18 illustrates the entirety of the game space 50. The stamp ST1-A is not illustrated in FIG. 18.

A player of a team recognizes intentions (for example, battle strategy) of players belonging to the same team by seeing the subsidiary object SO and the stamp ST. That is, based on the types of the subsidiary object SO and the stamp ST, a player manipulating the player character PC executing the target shooting delivers to other players in the same team what object is configured as a target and what action is executed or is wanted to be executed on the target.

Forms of the subsidiary object SO and the stamp ST are not limited to the forms described above.

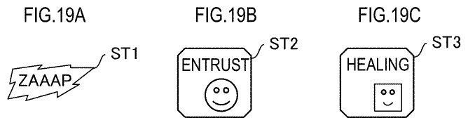

In the embodiment, there are two types of subsidiary objects SO1 and SO2 and three types of stamps ST1 to ST3. The subsidiary objects SO1 and SO2 have the same shape, and only color differs therebetween. As illustrated in FIGS. 19A to 19C, the stamps ST1 to ST3 have a planar shape containing messages (text and image).

The type of the subsidiary object SO is determined in response to a relationship between a team to which an object belongs which becomes a target and a team having the object as a target. The type of the stamp ST is determined in response to the relationship and the type of the object which is the target of the team. In the embodiment, the types of the subsidiary object SO and the stamp ST are determined with reference to a determination table illustrated in FIG. 20A. FIG. 20A illustrates an example of the determination table. The determination table includes a relationship field, a subsidiary object ID field, and a stamp ID field. The determination table is contained in game data.

Information indicating the relationship is configured in the relationship field. Specifically, information for specifying that the target is an enemy character or an enemy facility, an ally character, or an ally facility is configured. Each relationship is mapped onto a subsidiary object ID and a stamp ID. Subsidiary object identification information is configured in the subsidiary object ID field. Stamp identification information is configured in the stamp ID field.

If the target is the characters PC and NPC or the facilities 55 and 56 of an enemy team, the subsidiary object SO1 in red is generated. In this case, the stamp ST1 containing a message “ZAAP” indicating attack is also generated.

If the target is the character PC or NPC of an ally team, the subsidiary object SO2 in blue is generated. In this case, the stamp ST3 containing a message “healing” indicating recovery is also generated. If the target is the facility 55 or 56 of the ally team, the subsidiary object SO2 in blue is generated. In this case, the stamp ST2 containing a message “entrust” indicating defense is also generated.

In the embodiment, a terminal device of a player displays only the subsidiary object SO and the stamp ST of a player's own team. Therefore, combat strategies of the enemy team cannot be recognized.

Subsequently, occurrences of the subsidiary object SO and the like via the target shooting will be outlined. A case, in which the player character PC1-A belonging to the team A executes the target shooting at the facility 55-B belonging to the team B which is an enemy, will be described as an example with reference to FIGS. 16, 17A, and 17B.

Initially, the player character PC1-A moves close to (in a shooting range of the target shooting) to the facility 55-B. The player character PC1-A executes the target shooting at the facility 55-B. Therefore, as illustrated in FIG. 16, the moving body 60 is discharged onto the facility 55-B. Thereafter, if the facility 55-B is hit, the facility 55-B is configured as a target of the team A.

The subsidiary objects SO1-A along with the stamp ST1-A extend from the target (facility 55-B) to the player characters PC1-A to PC4-A of the team A. Thereafter, as illustrated in FIGS. 17A and 17B, the stamp ST1-A reaches the vicinity of each of the player characters PC1-A to PC4-A, and the subsidiary object SO1-A is completely generated to link the target (facility 55-B) to each of the player characters PC1-A to PC4-A of the team A.

Because the target (facility 55-B) is out of the imaging range of the virtual camera, the target (facility 55-B) is not displayed in the image illustrated in FIG. 17B. However, based on the subsidiary object SO1-A and the stamp ST1-A, a player manipulating a terminal device displaying the image illustrated in FIG. 17B can recognize which object is configured as a target by the player manipulating the player character PC executing the target shooting, and which action is executed on the target thereby.

In the embodiment, even though being in the combat-disable state, the player character PC can execute a movement and a target shooting motion. That is, until the player character PC in the combat-disable state is redisposed at the facility 56, the player can instruct the player character PC in the combat-disable state to execute the target shooting while moving the player character PC in the combat-disable state in the game space 50.

In the embodiment, if the target is configured, missions (sub-tasks) occur when a predetermined condition (occurrence condition) is established. Contents of the missions are configured based on the target with reference to a mission list. FIG. 21 illustrates an example of the mission list. The mission list includes a mission ID field, a description field, an occurrence condition field, a clear condition field, and an offered reward field, and is contained in the game data. Mission identification information is configured in the mission ID field. A mission ID is mapped onto a description, an occurrence condition, a clear condition, and an offered reward.

Text data indicating contents of a mission is configured in the description field. A mission occurrence condition is configured in the occurrence condition field. The occurrence condition contains at least a condition related to the target. A mission clear condition is configured in the clear condition field. That is, contents of a mission are configured. A reward, which is offered to a team when a mission is cleared, is configured in the offered reward field.

For example, in a mission having a mission ID: MS001, an occurrence condition implies that the target is the facility 55 of the enemy team and is not the facility 55 of the player's own team. A clear condition implies that the belonging team of the target (facility 55 belonging to the enemy team) is changed to the player's own team within a time limit (for example, 30 seconds). When the clear condition is satisfied, reward points: 500 points are offered to the team. Ina mission having a mission ID: MS003, an occurrence condition implies that the target is the facility 56 of the ally team and is selected by lottery with a predetermined probability. A clear condition implies that the target (facility 56) is not attacked until a time limit (for example, 30 seconds) has elapsed. When the clear condition is satisfied, reward points: 1000 points are offered to the team.

After the combat ends, the reward points offered to the team may be equally distributed to the player characters PC of the team. The reward point can be used (consumed) to increase a parameter of the player character PC. The mission may not occur in relation to the target.

In addition to a combat mode where a player participates in the combat, the game of the embodiment has an observation mode where the player himself or herself can observe the combat without participating in the play. In the observation mode, the display unit of the terminal device of an observer can display an image of the game space 50 for the combat. The observer can manipulate the position and the like of the virtual camera of the observer by manipulating the manipulation unit of the terminal device. The subsidiary objects SO and the stamps ST of both teams A and B are displayed in the image of the game space 50 of the observer. The observer (terminal device) can observe the game by sending an observation request (request for executing the observation mode) to the server device 10F. The terminal device of the observer transmits user identification information, an IP address, and the like when placing the observation request. The server device 10F may generate an observing player list from the received information, and store the observing player list in the storage unit.

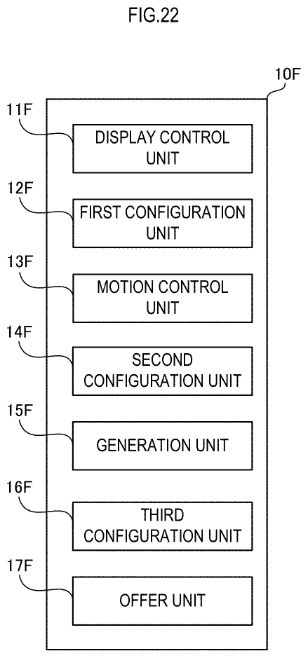

FIG. 22 is a functional block diagram illustrating a configuration of the server device 10F which is an example of the configuration of the server device 10. In this example, the server device 10F includes at least a display control unit 11F, a first configuration unit 12F, a motion control unit 13F, a second configuration unit 14F, a generation unit 15F, a third configuration unit 16F, and an offer unit 17F.

The display control unit 11F displays an image (game image) of a game space 50 on the display unit of each of the plurality of terminal devices 20 and 201 to 20N. The display control unit 11F regularly (one frame unit: 1/60 second) transmits control information (object control information) of objects, which contains movement (position) information and action execution information, to the terminal devices 20 and 201 to 20N as common image information. The terminal devices and 201 to 20N generate an image based on the image information, and display the image on the display units.

That is, the terminal devices 20 and 201 to 20N generate (update) the game space 50 based on the object control information, and generate an image via the virtual cameras which are disposed based on the player characters PC of the terminal devices. The object control information will be described later. The display control unit 11F transmits the image information to also the terminal device of an observing player.

The display control unit 11F may generate and transmit information on one frame of image as the image information, which is displayed on the display units of the terminal devices 20 and 201 to 20N.

The first configuration unit 12F configures a team (group) to which each of a plurality of the objects belongs. As described above, the first configuration unit 12F divides the plurality of objects such as the player character PC, the non-player character NPC, and the facilities 55 and 56 into two teams A and B. The first configuration unit 12F configures group identification information in the object control information (object list which will be described later).

The motion control unit 13F controls motions (actions) of the plurality of objects. The motion control unit 13F controls the motions based on update information and basic information on the player characters PC, which are acquired from the terminal devices 20 and 201 to 20N. The update information contains manipulation information of the player characters PC. The basic information on the player characters PC is acquired from the terminal devices of players manipulating the player characters PC. In the embodiment, player information containing the basic information is received at a request for participating in the game. The motion control unit 13F stores the acquired player information in the storage unit as a participating player list illustrated in FIG. 23A.

The participating player list includes a player ID field, a name field, and an in-use object field. Participating player identification information is configured in the player ID field. A player ID is mapped onto a user name and an in-use object. Text data indicating a player name is configured in the name field. Basic information on the player character PC manipulated by a participating player is configured in the in-use object field. For example, an object ID, a parameter, and the like are configured in the in-use object field. Identification information of the player character PC is configured in the object ID. Basic values of various parameters, for example, a maximum value of a vital power of the player character PC are configured in the parameters.

The motion control unit 13F causes the non-player character NPC to occur from the facility 55, and controls a motion of the non-player character NPC. The motion control unit 13F updates also the parameters such as vital powers of the characters PC and NPC based on a received attack.

The motion control unit 13F controls also motions of the facilities 55 and 56. The facility 55 is determined to be hit by attack from the player character PC, and a current value of a vital power (HP) of the facility 55 is updated. A change to the belonging team of the facility 55 is configured in response to the current value of the vital power. The facility 56 is determined to be hit by attack from the player character PC, and a current value of a vital power (HP) of the facility 56 is updated.

The motion control unit 13F updates the object control information by executing the control described above. The object control information is contained in the object list illustrated in FIG. 23B. FIG. 23B illustrates an example of the object list related to the player character PC. The object list includes an object ID field, a control information field, and a belonging group field. Player identification information is configured in the object ID field. An object ID is mapped onto control information and a belonging group.

The control information (object control information) of the player character PC is configured in the control information field. For example, a movement, an execution action, a vital power (current value), and the like are configured. A current position of the player character PC in the game space is configured as the movement. Coordinate information in a coordinate system of the game space is configured, for example. Information on a motion being executed by the player character PC is configured as the execution action. The type of a motion being executed, the degree of progression of the motion, and the like are configured, for example. Current values of various parameters such as vital power are configured as the parameters. Identification information of a belonging group of the player character PC is configured in the belonging group field.

Similar to the description above, the object control information is updated for also the non-player character NPC and the facilities 55 and 56, which is not illustrated. In this case, object identification information is configured in the object ID field.

Subsequently, the second configuration unit 14F configures at least one object of the plurality of objects as a target of a team, to which a player object belongs, based on a predetermined motion executed by the player character PC. The predetermined motion of the embodiment implies a motion of hitting an object with the moving body 60 via the target shooting. The second configuration unit 14F configures the object, which is hit by the moving body 60, as the target. If an object which is a target for the target shooting is not hit, the configuring is not executed. As described above, the targeted objects are the player character PC, the non-player character NPC, and the facilities 55 and 56.

A target shooting motion of the player character PC is also controlled by the motion control unit 13F. The object control information of the moving body 60 is also generated, and a movement and hit determination of the moving body 60 are also controlled by the motion control unit 13F. In the embodiment, when an object (obstacle object) which is an obstacle is present on a movement path, the moving body 60 moves while penetrating through the obstacle object. That is, the obstacle object is not considered into the controlling of movement of the moving body 60. The obstacle object is an object restricting a movement of the player character PC. Objects such as trees, rocks, and buildings correspond to the obstacle objects, for example.

The second configuration unit 14F configures targets in the target list (target configuration information) illustrated in FIG. 20B. FIG. 20B illustrates an example of the target list. The target list includes a target ID field, a group ID field, a subsidiary object ID field, and a stamp ID field, and is stored in the storage unit of the server device 10F. In the target list illustrated in FIG. 20B, three targets in combination with the teams A and B are configured.

Identification information of an object which is a target is configured in the target ID field. A target ID is mapped onto a group ID, a subsidiary object ID, and a stamp ID. Identification information of a targeted group (team) is configured in the group ID field. Identification information of the subsidiary object SO, which is mapped onto the target as described above, is configured in the subsidiary object ID field. Identification information of the stamp ST, which is mapped onto the target as described above, is configured in the stamp ID field.

When a mission occurs, the second configuration unit 14F removes information on a corresponding target from the target list at the time of confirmation of a success or a failure of the mission.

When a new target is configured, the second configuration unit 14F configures the target by adding an object ID, a group ID, and a release timer of the target to the target list. Subsidiary objects ID and stamps ID are configured by the generation unit 15F.

Subsequently, the generation unit 15F generates the subsidiary object SO linking a target of a team (group) to each of player characters PC belonging to the group. The generation unit 15F generates the subsidiary object SO by referring to the determination table and the like, and configuring a subsidiary object ID for a corresponding target (target ID) in the target list. The generation unit 15F generates the stamp ST by referring to the determination table and the like, and configuring a stamp ID for a corresponding target (target ID) in the target list.

When a target of a team is configured, the third configuration unit 16F configures a sub-task (mission) of the team based on the target. As described above, when an occurrence condition is determined to be satisfied with reference to the mission list illustrated in FIG. 21, the third configuration unit 16F causes a mission of a corresponding team to occur (configure).

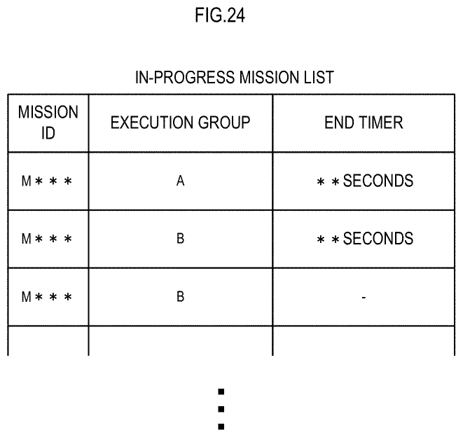

The third configuration unit 16F configures a sub-task (mission) for a team by configuring information on occurring missions in an in-progress mission list. FIG. 24 illustrates an example of the in-progress mission list. The in-progress mission list is stored in the storage unit of the server device 10F while Information on currently occurring missions is configured therein.

The in-progress mission list includes a mission ID field, a group ID field, and an end timer field. In-progress mission identification information is configured in the mission ID field. A mission ID is mapped onto a group ID and an end timer. Identification information of a group (team) having occurring missions is configured in the group ID field. A time limit (remaining time) of a mission, of which a clear condition contains the time limit, is configured in the end timer field. The third configuration unit 16F determines a success or a failure of the mission as the time limit decreases.

When a success or a failure of the mission is confirmed, the third configuration unit 16F removes information on the corresponding mission from the in-progress mission list.

When the sub-task (mission) has been accomplished, the offer unit 17F offers a reward to a group (team) which has made the accomplishment or player characters (players) belonging to the team. As described above, offered rewards corresponding to the mission list are offered to the team. The offer unit 17F stores the rewards, which are offered to each team, in the storage unit from the start to the end of the combat. At the end of the combat, the offer unit 17F equally distributes the acquired rewards of the team to the player characters PC (players) of the team. The offer unit 17F may add, for example, reward contents to player data of a player manipulating each player character PC.

Instead of the rewards being offered to the team, rewards may be directly offered to the player characters PC belonging to a team which has accomplished a mission.

The display control unit 11F regularly transmits also the target list, which contains information on the subsidiary object SO and the stamp ST, to the terminal devices 20 and 201 to 20N as object control information (image information). The terminal devices 20 and 201 to 20N specify the position of the target and the position of the player character PC with reference to the target list, the object control information, and the like, and dispose the subsidiary object SO and the stamp ST in the game space 50.

In the embodiment, the display control unit 11F sends only information on a target of a group to any of the terminal devices 20 and 201 to 20N, which belongs to the group. Only information on a target of the team A in the target list is sent to a terminal device of a player manipulating a player character belonging to the team A, but information on a target of the team B is not transmitted thereto.

The entire information in the target list may be transmitted to the terminal devices 20 and 201 to 20N. In this case, the subsidiary object SO and the stamp ST are selected which are displayed in each of the terminal devices 20 and 201 to 20N.

When a mission is newly configured, the display control unit 11F transmits and displays mission contents (text data in the “description” field of the mission list) in the terminal devices 20 and 201 to 20N. Similar to the target list, the display control unit 11F may send only information on a mission of a belonging group.

The display control unit 11F transmits the target list and the mission contents to a terminal device of an observer regardless of which team the observer is on.

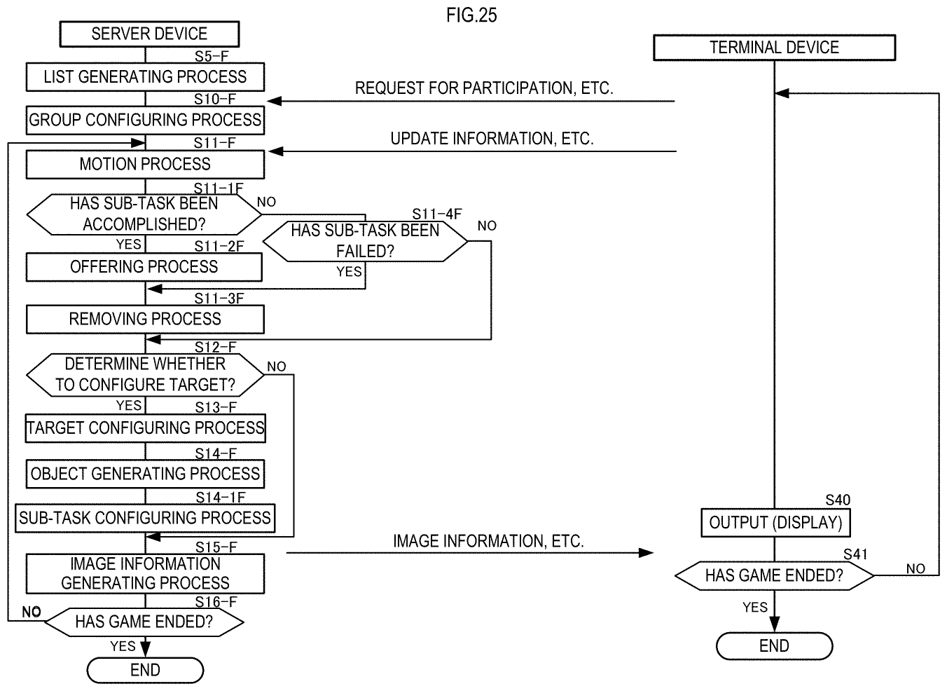

FIG. 25 is a flowchart illustrating an example of a progression process of a game which is executed by the system 100. In the progression process of the embodiment, a game progression process containing a team (group) configuring process, a group target configuring process, and a process of generating the subsidiary object SO and the stamp ST is executed. In FIG. 25, the group configuring process, the group target configuring process, the process of generating the subsidiary object SO and the stamp ST will be mainly described, and part of other processes will be omitted. In a description of an example hereinbelow, the server device 10F and the terminal device 20 execute the progression process. A description of the flowchart illustrating the motion of the host terminal device will be omitted from the viewpoint of avoiding the duplication of the description.

The progression process of the embodiment is executed in response to the occasion that a player generates a manipulation input for requesting game participation.

In the progression process, the terminal device 20 transmits game participation request information to the server device 10F. The participation request information contains basic information of the player character PC manipulated by a player, an IP address, user identification information, and the like. The server device 10F generates the participating player list (illustrated in FIG. 23A) based on the received participation request, and stores the participating player list in the storage unit (Step S5-F).

Subsequently, the server device 10F executes the group configuring process (Step S10-F). The server device 10F generates the object list (illustrated in FIG. 23B) with reference to the participating player list and the like, and stores the object list in the storage unit. A group for each object is also configured. Thereafter, the game space 50 is generated and the game starts. The terminal device 20 regularly transmits update information (manipulation information and the like) of the player character PC to the server device 10F.

Subsequently, the server device 10F executes a motion process of the objects in the game space 50 (Step S11-F). As described above, the server device 10F causes at least a plurality of the objects, for which a group is configured, to move based on the update information of the player character PC, and the like. When a motion of each player character PC is determined to be a restricted motion based on a current value of a vital power, the server device 10F does not execute the motion. As described above, the server device 10F updates also the current value of the vital power of each player object in response to a received attack. The server device 10F updates object control information, for example, information on a movement (position) of each object in the game space 50 and action execution information.

Thereafter, the server device 10F determines if there are accomplished (cleared) missions (sub-tasks) under configuration (progress) (Step S11-1F). As described above, with reference to the mission list, the in-progress mission list, and the like, and based on clear conditions, the server device 10F determines whether the in-progress missions have been accomplished. The server device 10F makes determinations on all the in-progress missions.

When there are the accomplished in-progress missions (Step S11-1F: YES), the server device 10F executes the reward offering process (Step S11-2F). As described above, the server device 10F offers the rewards, which are configured in the mission list, to a team which has accomplished the missions. The server device 10F removes information on the accomplished missions from the in-progress mission list (Step S11-3F). Thereafter, the server device 10F proceeds to the process of Step S12-F.

When there are no accomplished in-progress missions (Step S11-1F: NO), the server device 10F determines whether there are failed in-progress missions (Step S11-4F). When there are no failed in-progress missions (Step S11-4F: NO), the server device 10F proceeds to the process of Step S12-F. On the other hand, when there are the failed in-progress missions (Step S11-4F: YES), the server device 10F removes information on the failed missions from the in-progress mission list (Step S11-3F).

Subsequently, the server device 10F determines whether to configure targets of teams (Step S12-F). Specifically, the server device 10F makes determinations based on whether a target is hit by the moving body 60 which is discharged by target shooting executed by the player character PC belong to a team. The object control information updated in the process of Step S11-F may be referred to for the motions of the player character PC and the moving body 60.

When it is determined that the configuring of the target is not required (Step S12-F: NO), the server device 10F proceeds to the process of Step S16-F. On the other hand, when it is determined that the configuring of the target is required (Step S12-F: YES), the server device 10F executes the target configuring process (Step S13-F). That is, the server device 10F configures information on newly added targets in the target list.

Subsequently, the server device 10F executes the object generating process (Step S14-F). Specifically, with reference to the determination table, the server device 10F configures information on the subsidiary object SO and the stamp ST of the target (target ID), which is newly configured in the process of Step S13-F, in the target list.

The server device 10F executes the sub-task configuring process (Step S14-1F). The server device 10F configures missions (causes missions to occur) with reference to the mission list (occurrence condition) and based on the targets configured in the process of Step S13-F. That is, the server device 10F configures information on newly configured missions in the in-progress mission list.

Thereafter, the server device 10F executes the image information generating process (Step S15-F). The server device 10F transmits image information to the terminal device 20. The server device 10F generates the object list (object control information) and the like, which are updated in the motion process of Step S11-F, as the image information. The server device 10F causes the image information to contain also the target list. At this time, target list information is generated for each team. Thereafter, the server device 10F transmits the image information to the terminal device 20. The terminal device 20 is specified from the IP addresses, the user identification information, and the like which are received at the request for participation.

The server device 10F transmits the same image information to also the terminal device of the observing player. In this case, the server device 10F causes the image information to contain the entire target list.

Subsequently, the server device 10F determines whether the game ends (Step S16-F). The server device 10F determines confirmation of victory or defeat in the combat as the end of the game. When the game has not ended (Step S16-F: NO), the server device 10F returns to the process of Step S11-F. On the other hand, when the game has ended (Step S16-F: YES), the server device 10F ends the game progression process. When it is determined that the game has ended, reward points offered to a team may be equally distributed to player objects belonging to the team.

Until the game ends (Step S41: YES), the terminal device 20 outputs an image of the game space 50 (displays an image of the game space 50 on the display unit) based on the received image information (Step S40).

As described above, according to one aspect of the sixth embodiment, because the server device 10F includes at least the display control unit 11F, the first configuration unit 12F, the motion control unit 13F, the second configuration unit 14F, and the generation unit 15F, the third configuration unit 16F, and the offer unit 17F, the server device 10F generates a subsidiary object linking a target of a group (team) to each of player objects (player characters) belonging to the group. Therefore, a player can easily recognize other players' thoughts from the subsidiary objects. Moreover, because the target is configured and the subsidiary objects are generated based on the predetermined motion of a player object manipulated by the player, a manipulation of generating the subsidiary objects also becomes easy. Therefore, an improvement in convenience of a communication function in the game is obtained.

Because subsidiary objects are generated in response to the relationship between a group, to which an object belongs which is a target of a group, and the group having the object as a target, a player can easily recognize other players' thoughts from each subsidiary object. Therefore, a higher improvement in convenience of the communication function is obtained.

A subsidiary object for a target of a group is displayed on a terminal device for a player object belonging to the group. Therefore, it is possible to prevent contents, for example, combat strategy of communication within a group from being specified to player objects (players) of other groups. As a result, a higher improvement in convenience of the communication function is obtained.

Even though a player object is in the predetermined state, because a movement and the predetermined motions are not restricted, the communication function operates even in the predetermined state. Therefore, even though the player object is a player inexperienced in the game, for example, a beginner who is likely to enter the predetermined state, the player object can support other players via communication within at least the group.

Because sub-tasks (missions) are configured for a group by configuring a target of the group, an interest in the game improves.

In the embodiment, the server device receives manipulation information from the terminal devices as update information; however, the present disclosure is not particularly limited to the configuration of the embodiment. A motion of a player object manipulated by a player may be executed in a terminal device used by the player, and updated control information (for example, movement (position) information of the player object and action execution information) may be transmitted to the server device as update information.

In the embodiment, a combat between groups of teams has been described; however, the present disclosure is not limited to the combat form. The present disclosure may adopt, for example, a configuration where groups are formed and items hidden in a game space are searched.

In the embodiment, one object is configured as a target; however, a plurality of objects may be able to be configured as targets via one predetermined motion. If the predetermined motion is not a motion of shooting a moving body, but a motion of designating a region in the game space, a plurality of objects in the designated region are configured as targets.

In the embodiment, information on the targets, the subsidiary objects, and the stamps is removed from the target list depending on whether missions have been accomplished or failed; however, the present disclosure is not particularly limited to the configuration of the embodiment. The information may be removed after a time limit (for example, minutes) has elapsed from the point of generation. Alternatively, a manipulation of cancelling the target may be received. In this case, a cancellation manipulation from only a player executing the predetermined motion may be received.

In the embodiment, when missions (sub-tasks) occur, player characters belonging to a team related to the missions basically become participants for the missions; however, the present disclosure is not particularly limited to the configuration of the embodiment. For example, when a mission occurs, the third configuration unit may receive players (or player characters) participating in the mission. In this case, only player characters of players, of which mission participation requests are received from terminal devices, are configured as characters participating in the mission. Rewards maybe offered in response to the number of participants for missions. For example, the more the number of participants is, the higher rewards are offered.

In the embodiment, the target shooting implies that the moving body hits only objects positioned in a discharge direction; however, the present disclosure is not limited to the configuration of the embodiment. If the target shooting is executed in a state where a targeted object is aimed, the object may be certainly hit. Specifically, the server device controls the discharge direction (movement direction) such that the moving body is discharged to the position of the aimed (overlapped) object. When the object moves after the moving body has been discharged, the server device controls the movement direction of the moving body to trace the movement of the object.

In the example, the distance between the object and a player character executing the target shooting may not be taken into consideration. That is, regardless of the distance, the moving body certainly hits the aimed object. The player may execute a manipulation of moving an aiming position such that the aiming position overlaps the object. Alternatively, the server device may control the aiming position such that the aiming position automatically overlaps the targeted object (automatic aiming).

In the case of automatic aiming, an object is aimed which is in the imaging range of the virtual camera and is the nearest to the player character. A target of the automatic aiming may be limited to an object which can become a target of a group. In the embodiment, a player character, a non-player character, or a facility may become a target of the automatic aiming, for example. In the automatic aiming, an obstacle object may not be taken into consideration. That is, even though an obstacle object is between a player character and an object at which the moving body is to be aimed, the object is aimed.

As described above, because an object is easily hit by target shooting, the use of target shooting becomes easy, and an opportunity of communication within a group increases.

### APPENDIX

According to the description of the embodiments, persons having common knowledge in the field of the invention can realize at least the invention hereinbelow.

[1] There is provided a video game processing program that causes a computer to realize a function of controlling a progression of a video game in which each group is formed in a game space by a plurality of objects containing player objects which are respectively manipulated by players of a plurality of terminal devices connected together via a communication network, the program causing the computer to realize a display control function that displays an image of the game space on a display unit of each of the plurality of terminal devices; a first configuration function that configures a group to which each of the plurality of objects belongs; a motion control function that controls motions of the plurality of objects; a second configuration function that configures at least one object of the plurality of objects as a target of a group to which a player object belongs, based on a predetermined motion executed by the player object; and a generation function that generates a subsidiary object linking the target of the group to each player object belonging to the group.

[2] In the video game processing program described in [1], the generation function generates the subsidiary objects in response to a relationship between a group, to which the object belongs which is the target of the group, and the group having the object as a target.

[3] In the video game processing program described in either [1] or [2], the display control function displays an image of the game space, which contains the subsidiary object, on the display units of the terminal devices corresponding to the player objects in the target of the group, which belong to the group.

[4] In the video game processing program described in any of [1] to [3], when a player object enters a predetermined state in response to an occasion of being attacked by other objects, the motion control function restricts execution of part of motions of the player object, which does not contain a movement and the predetermined motion.

[5] The video game processing program described in any of [1] to [4] further causes the computer to realize a third configuration function that, when the target of the group is configured, configures a sub-task for the group, and an offer function that, when the sub-task has been accomplished, offers a reward to a group which has made the accomplishment, or player objects belonging to the group.

[6] In the video game processing program described in [5], the third configuration function receives a participation in the sub-task, which is configured for the group, from the player objects belonging to the group or players manipulating the player objects, and the offer function offers the reward in response to the number of participants of the sub-task.

[7] In the video game processing program described in [6], when the sub-task has been accomplished, the offer function offers the reward regardless of victory or defeat in a combat of the group.

[8] In the video game processing program described in [2], the types of the plurality of objects are configured, and the display control function displays a message that is displayed along with the subsidiary object, and is based on the relationship and the type of the object which is the target of the group.

[9] In the video game processing program described in any of [1] to [8], the motion control function executes a motion of outputting a moving object from a player object to another object, as the predetermined motion, and controls a movement of the moving object, and the second configuration function configures the other object, which is hit by the moving object, as a target of a group to which the player object executing the predetermined motion belongs.

[10] In the video game processing program described in [9], an obstacle object restricting a movement of the player object is disposed in the game space, and the motion control function controls a movement motion of the moving object without reference to a position of the obstacle object.

[11] In the video game processing program described in any of [1] to [10], the display control function displays an image of the game space of a combat of the groups, which contains the subsidiary object, on a display unit of a terminal device of a user not participating in a play of the game.

[12] There is provided a server device in which the video game processing program described in any of [1] to [11] is installed.

[13] There is provided a terminal program that causes a game terminal device to realize a function of displaying a game screen on a display screen of a display unit and executing a video game, the program causing the game terminal device to realize a connection function that connects the game terminal device with the server device, which is described in [12] , via a communication network.

[14] There is provided a game terminal device in which the video game processing program described in any of [1] to [11] is installed.

[15] There is provided a video game processing program that causes a server device to control a progression of a video game in which each group is formed in a game space by a plurality of objects containing player objects which are respectively manipulated by players of a plurality of terminal devices connected with the server device via a communication network, the program causing the server device to realize a display control function that displays an image of the game space on a display unit of each of the plurality of terminal devices a first configuration function that configures a group to which each of the plurality of objects belongs; a motion control function that controls motions of the plurality of objects; a second configuration function that configures at least one object of the plurality of objects as a target of a group to which a player object belongs, based on a predetermined motion executed by the player object; and a generation function that generates a subsidiary object linking the target of the group to each player object belonging to the group.

[16] In the video game processing program described in [15], the generation function generates the subsidiary objects in response to a relationship between a group, to which the object belongs which is the target of the group, and the group having the object as a target.

[17] In the video game processing program described in either [15] or [16], the display control function displays an image of the game space, which contains the subsidiary object, on the display units of the terminal devices corresponding to the player objects in the target of the group, which belong to the group.

[18] In the video game processing program described in any of [15] to [17], when a player object enters a predetermined state in response to an occasion of being attacked by other objects, the motion control function restricts execution of part of motions of the player object, which does not contain a movement and the predetermined motion.

[19] The video game processing program described in any of [15] to [18] further causes the server device to realize a third configuration function that, when the target of the group is configured, configures a sub-task for the group, and an offer function that, when the sub-task has been accomplished, offers a reward to a group which has made the accomplishment, or player objects belonging to the group.

[20] In the video game processing program described in [19], the third configuration function receives a participation in the sub-task, which is configured for the group, from the player objects belonging to the group or players manipulating the player objects, and the offer function offers the reward in response to the number of participants of the sub-task.

[21] In the video game processing program described in [20], when the sub-task has been accomplished, the offer function offers the reward regardless of victory or defeat in a combat of the group.

[22] In the video game processing program described in [16], the types of the plurality of objects are configured, and the display control function displays a message that is displayed along with the subsidiary object, and is based on the relationship and the type of the object which is the target of the group.

[23] In the video game processing program described in any of [15] to [22], the motion control function executes a motion of outputting a moving object from a player object to another object, as the predetermined motion, and controls a movement of the moving object, and the second configuration function configures the other object, which is hit by the moving object, as a target of a group to which the player object executing the predetermined motion belongs.

[24] In the video game processing program described in [23], an obstacle object restricting a movement of the player object is disposed in the game space, and the motion control function controls a movement motion of the moving object without reference to a position of the obstacle object.

[25] In the video game processing program described in any of [15] to [24], the display control function displays an image of the game space of a combat of the groups, which contains the subsidiary object, on a display unit of a terminal device of a user not participating in a play of the game.

[26] A game system that includes a plurality of terminal devices executing a video game in which each group is formed in a game space by a plurality of objects containing player objects which are respectively manipulated by a plurality of players, and a server device connected with the plurality of terminal devices via a communication network, the system including a display controller that displays an image of the game space on a display unit of each of the plurality of terminal devices; a first configurator that configures a group to which each of the plurality of objects belongs; a motion controller that controls motions of the plurality of objects; a second configurator that configures at least one object of the plurality of objects as a target of a group to which a player object belongs, based on a predetermined motion executed by the player object; and a generator that generates a subsidiary object linking the target of the group to each player object belonging to the group.

[27] There is provided a host terminal device that is connected with other terminal devices via a communication network, and controls a progression of a video game in which each group is formed in a game space by a plurality of objects containing player objects which are respectively manipulated by a plurality of players, the device including a display controller that displays an image of the game space on a display unit of each of the plurality of terminal devices; a first configurator that configures a group to which each of the plurality of objects belongs; a motion controller that controls motions of the plurality of objects; a second configurator that configures at least one object of the plurality of objects as a target of a group to which a player object belongs, based on a predetermined motion executed by the player object; and a generator that generates a subsidiary object linking the target of the group to each player object belonging to the group.

[28] A video game processing method of causing a computer to realize a function of controlling a progression of a video game in which each group is formed in a game space by a plurality of objects containing player objects which are respectively manipulated by players of a plurality of terminal devices connected together via a communication network, the method including a display control process of displaying an image of the game space on a display unit of each of the plurality of terminal devices; a first configuration process of configuring a group to which each of the plurality of objects belongs; a motion control process of controlling motions of the plurality of objects; a second configuration process of configuring at least one object of the plurality of objects as a target of a group to which a player object belongs, based on a predetermined motion executed by the player object; and a generation process of generating a subsidiary object linking the target of the group to each player object belonging to the group.

One embodiment of the invention is effective in improving convenience of the communication function in the video game.

What is claimed is:

1. A video game processing program that causes a computer to realize a function of controlling a progression of a video game in which each group is formed in a game space by a plurality of objects containing player objects which are respectively manipulated by players of a plurality of terminal devices connected together via a communication network, the program causing the computer to realize:
a display control function that displays an image of the game space on a display unit of each of the plurality of terminal devices;
a first configuration function that configures a group to which each of the plurality of objects belongs;
a motion control function that controls motions of the plurality of objects;
a second configuration function that configures at least one object of the plurality of objects as a target of a group to which a player object belongs, based on a predetermined motion executed by the player object; and
a generation function that generates a subsidiary object linking the target of the group to each player object belonging to the group.

2. The video game processing program according to claim 1,
wherein the generation function generates the subsidiary objects in response to a relationship between a group, to which the object belongs which is the target of the group, and the group having the object as a target.

3. The video game processing program according to claim 1,
wherein the display control function displays an image of the game space, which contains the subsidiary object, on the display units of the terminal devices corresponding to the player objects in the target of the group, which belong to the group.

4. The video game processing program according to claim 1,
wherein when a player object enters a predetermined state in response to an occasion of being attacked by other objects, the motion control function restricts execution of part of motions of the player object, which does not contain a movement and the predetermined motion.

5. The video game processing program according to claim 1, further causing the computer to realize:
a third configuration function that, when the target of the group is configured, configures a sub-task for the group, and
an offer function that, when the sub-task has been accomplished, offers a reward to a group which has made the accomplishment, or player objects belonging to the group.

6. The video game processing program according to claim 5,
wherein the third configuration function receives a participation in the sub-task, which is configured for the group, from the player objects belonging to the group or players manipulating the player objects, and
wherein the offer function offers the reward in response to the number of participants of the sub-task.

7. The video game processing program according to claim 6,
wherein when the sub-task has been accomplished, the offer function offers the reward regardless of victory or defeat in a combat of the group.

8. The video game processing program according to claim 2,
wherein the types of the plurality of objects are configured, and
wherein the display control function displays a message that is displayed along with the subsidiary object, and is based on the relationship and the type of the object which is the target of the group.

9. The video game processing program according to claim 1,
wherein the motion control function
executes a motion of outputting a moving object from a player object to another object, as the predetermined motion, and
controls a movement of the moving object, and
wherein the second configuration function configures the other object, which is hit by the moving object, as a target of a group to which the player object executing the predetermined motion belongs.

10. The video game processing program according to claim 9,
wherein an obstacle object restricting a movement of the player object is disposed in the game space, and
wherein the motion control function controls a movement motion of the moving object without reference to a position of the obstacle object.

11. The video game processing program according to claim 1,
wherein the display control function displays an image of the game space of a combat of the groups, which contains the subsidiary object, on a display unit of a terminal device of a user not participating in a play of the game.

12. A video game processing program that causes a server device to control a progression of a video game in which each group is formed in a game space by a plurality of objects containing player objects which are respectively manipulated by players of a plurality of terminal devices connected with the server device via a communication network, the program causing the server device to realize:
a display control function that displays an image of the game space on a display unit of each of the plurality of terminal devices;
a first configuration function that configures a group to which each of the plurality of objects belongs;
a motion control function that controls motions of the plurality of objects;
a second configuration function that configures at least one object of the plurality of objects as a target of a group to which a player object belongs, based on a predetermined motion executed by the player object; and
a generation function that generates a subsidiary object linking the target of the group to each player object belonging to the group.

13. A game system that includes a plurality of terminal devices executing a video game in which each group is formed in a game space by a plurality of objects containing player objects which are respectively manipulated by a plurality of players, and a server device connected with the plurality of terminal devices via a communication network, the system comprising:
a display controller that displays an image of the game space on a display unit of each of the plurality of terminal devices;
a first configurator that configures a group to which each of the plurality of objects belongs;
a motion controller that controls motions of the plurality of objects;
a second configurator that configures at least one object of the plurality of objects as a target of a group to which a player object belongs, based on a predetermined motion executed by the player object; and
a generator that generates a subsidiary object linking the target of the group to each player object belonging to the group.
